(19) United States
(12) Patent Application Publication
(10) Pub. No.: US 2025/0290948 A1
(43) Pub. Date: Sep. 18, 2025

(54) Atomic Force Microscope Based Infrared Spectroscopy With Multiple Laser Pulse Repetition Rate Excitation And Optional Force Volume Operation

(71) Applicant: Bruker Nano, Inc., Santa Barbara, CA (US)

(72) Inventors: Martin Wagner, Goleta, CA (US); Shuiqing Hu, Goleta, CA (US); Weijie Wang, Thousand Oaks, CA (US); Chanmin Su, Ventura, CA (US); Peter Dewolf, Saint Remeze (FR)

(21) Appl. No.: 19/060,266

(22) Filed: Feb. 21, 2025

Related U.S. Application Data
(60) Provisional application No. 63/556,743, filed on Feb. 22, 2024.
(60) Provisional application No. 63/682,158, filed on Aug. 12, 2024.

(51) Int. Cl. G01Q 20/02; G01Q 10/04; G01Q 10/06; G01Q 60/34; G01Q 60/38

(52) U.S. Cl. CPC G01Q 20/02; G01Q 10/045; G01Q 10/065; G01Q 60/34; G01Q 60/38

(57) ABSTRACT

An apparatus and method directed to sample characterization with an AFM using a pulsed IR laser in force volume mode, i.e., force volume mode combined with AFM-IR, referred to herein as FV AFM-IR. In this way, lateral forces are suppressed during probe positioning, and precise force control allows adjusting the tip-sample interaction force, including keeping the tip-sample interaction force constant or exerting pulling forces. Nano-spectroscopic measurements with sub-20 nm, and even sub-10 nm resolution can be acquired together with nano-mechanical and other property measurements. Notably, probe resonance shifts can be compensated with frequency tracking methods, and signal normalization by the Q-factor can be used to ensure that the extracted light-induced surface pulse force is substantially independent of damping.

### CROSS-REFERENCE TO RELATED APPLICATIONS

This application claims priority under 35 U.S.C. § 1.119 (e) to U.S. Provisional Patent Application Nos. 63/556,743, filed Feb. 22, 2024, and 63/682,158, filed Aug. 12, 2024. The subject matter of these applications are hereby incorporated by reference in their entirety.

### BACKGROUND OF THE INVENTION

### Field of the Invention

The preferred embodiments are directed to making nano-spectroscopy measurements using Atomic Force Microscopy (AFM) operation that remove mechanically-induced artifacts in the nano-spectroscopy data. This is accomplished by measuring the light induced surface pulse force at multiple pulse repetition rates of the light source. AFM operational modes are amongst others tapping mode, contact mode, force volume mode and peak force tapping mode. Force volume mode in particular is a preferred embodiment that combines nanomechanical with nanochemical spectroscopy measurements while minimizing lateral forces.

### Description of Related Art

Infrared spectroscopy and scanning probe microscopy (SPM) have been combined to perform a method of spectroscopy that integrates an infrared light source, e.g., a tunable free electron laser, an optical parametric oscillator or a quantum cascade laser with an atomic force microscope (AFM) having a sharp probe that measures the local absorption of infrared light by a sample. Conventional techniques in this regard are based on contact-mode AFM and extract the absorption signal from contact resonance oscillations that occur when the sample expands (or contracts) during light absorption. Recently, a tapping mode based AFM technique using infrared (IR) illumination has been shown to yield a spatial resolution down to 10 nm. Even more recently, PeakForce IR, an IR spectroscopy and imaging mode based on Peak Force tapping AFM operational mode has been developed with 10 nm resolution.

In general, the interaction between a sample under test and electromagnetic energy can be monitored to yield information concerning the sample. In spectroscopy, transmission of light through a sample or its reflection off a sample results in a sample-characteristic plot of transmitted or reflected intensity as a function of wavelength. This spectroscopic information allows users to determine the physical properties of the sample, such as chemical composition or temperature.

Notably, making spectroscopic measurements with a spatial resolution on the nanoscale is continuing to improve. However, despite ongoing progress in the development of imaging techniques with spatial resolution beyond the diffraction limit, simultaneous spectroscopic implementations delivering chemical specificity and sensitivity on the molecular level have remained challenging.

SPMs are facilitating improvements in this area. AFMs are devices which typically employ a probe having a tip and causing the tip to interact with the surface of a sample with appropriate forces to characterize the surface down to atomic dimensions. Generally, the probe is introduced to a surface of a sample to detect changes in the characteristics of a sample. By providing relative scanning movement between the tip and the sample, surface characteristic data can be acquired over a particular region of the sample and a corresponding map of the sample can be generated.

A typical AFM system is shown schematically in FIG. 1. An AFM 10 employs a probe device 12 including a probe 14 having a cantilever 15 extending from a base 19. Scanner 24 generates relative motion between the probe 14 and sample 22 while the probe-sample interaction is measured. In this way images or other measurements of the sample can be obtained. Scanner 24 is typically comprised of one or more actuators that usually generate motion in three orthogonal directions (XYZ). Often, scanner 24 is a single integrated unit that includes one or more actuators to move either the sample or the probe in all three axes, for example, a piezoelectric tube actuator. Alternatively, the scanner may be an assembly of multiple separate actuators. Some AFMs separate the scanner into multiple components, for example an XY scanner that moves the sample and a separate Z-actuator that moves the probe. The instrument is thus capable of creating relative motion between the probe and the sample while measuring the topography or some other surface property of the sample as described, e.g., in Hansma et al. U.S. Pat. No. RE 34,489; Elings et al. U.S. Pat. No. 5,266,801; and Elings et al. U.S. Pat. No. 5,412,980.

In a common configuration, probe 14 is often coupled to an oscillating actuator 16 that is used to drive probe 14 at or near a resonant frequency of cantilever 15. Alternative arrangements measure the deflection, torsion, or other motion of cantilever 15. Probe 14 is often a microfabricated cantilever with an integrated tip 17.

Commonly, an electronic signal is applied from an AC signal source or drive 18 under control of an SPM controller 20 to cause actuator 16 to drive the probe 14 to oscillate (and/or a scanner 24 to oscillate the sample, for example). The probe-sample interaction is typically controlled via feedback by controller 20. Notably, the actuator 16 may not be coupled to scanner 24 and probe 14 but may be formed integrally with the cantilever 15 of probe 14 as part of a self-actuated cantilever/probe.

Often a selected probe 14 is oscillated and brought into contact with sample 22 as sample characteristics are monitored by detecting changes in one or more characteristics of the oscillation of probe 14, as described above. In this regard, a deflection detection apparatus 25 is typically employed to direct a beam towards the backside of probe 14, the beam then being reflected towards a detector 26. As the beam translates across detector 26, appropriate signals are processed at block 28 to, for example, determine RMS deflection and transmit the same to controller 20, which processes the signals to determine changes in the oscillation of probe 14. In general, controller 20 generates control signals to maintain a relative constant interaction between the tip and sample (or deflection of the lever 15), typically to maintain a setpoint characteristic of the oscillation of probe 14. More particularly, controller 20 may include a PI Gain Control block 32 and a High Voltage Amplifier 34 that condition an error signal obtained by comparing, with circuit 30, a signal corresponding to probe deflection caused by tip-sample interaction with a setpoint. For example, controller 20 is often used to maintain the oscillation amplitude at a setpoint value, A_{S}, to insure a generally constant force between the tip and sample. Alternatively, a setpoint phase or frequency may be used.

A workstation 40 is also provided, in the controller 20 and/or in a separate controller or system of connected or stand-alone controllers, that receives the collected data from the controller and manipulates the data obtained during scanning to perform point selection, curve fitting, and distance determining operations.

AFMs may be designed to operate in a variety of modes, including contact mode and oscillating mode. Operation is accomplished by moving either the sample or the probe assembly up and down relatively perpendicular to the surface of the sample in response to a deflection of the cantilever of the probe assembly as it is scanned across the surface. Scanning typically occurs in an “x-y” plane that is at least generally parallel to the surface of the sample, and the vertical movement occurs in the “z” direction that is perpendicular to the x-y plane. Note that many samples have roughness, curvature and tilt that deviate from a flat plane, hence the use of the term “generally parallel.” In this way, the data associated with this vertical motion can be stored and then used to construct an image of the sample surface corresponding to the sample characteristic being measured, e.g., surface topography. The surface topography is usually the height or height sensor data. Height data corresponds to the change in voltage of the piezoelectric Z-scanner 24 that is needed to keep, for instance, the cantilever deflection constant at a setpoint (e.g., in contact mode), or keep the cantilever oscillation amplitude constant at a setpoint in oscillating mode. Note that sometimes a separate Z-actuator 16 is used for moving the probe instead of the sample. Height sensor data corresponds to the sensor measured change in piezo height needed to keep the cantilever deflection constant, for instance, or the oscillation amplitude. It is the physical displacement of the piezo as measured by a sensor.

In one mode of AFM operation, known as TappingMode™ AFM (TappingMode™ is a trademark of the present assignee), the tip is oscillated at or near a resonant frequency of the associated cantilever of the probe. A feedback loop attempts to keep the amplitude of this oscillation constant to minimize the “tracking force,” i.e., the force resulting from tip/sample interaction. Alternative feedback arrangements keep the phase or oscillation frequency constant. As in contact mode, these feedback signals are then collected, stored, and used as data to characterize the sample. Note that “SPM” and the acronyms for the specific types of SPMs, may be used herein to refer to either the microscope apparatus or the associated technique, e.g., “atomic force microscopy.” In a recent improvement on the ubiquitous TappingMode™, called Peak Force Tapping® (PFT) Mode, discussed in U.S. Pat. Nos. 8,739,309, 9,322,842 and 9,588,136, which are expressly incorporated by reference herein, feedback is based on force (also known as a transient probe-sample or tip-sample interaction force) as measured in each oscillation cycle.

Regardless of their mode of operation, AFMs can obtain resolution down to the atomic level on a wide variety of insulating or conductive surfaces in air, liquid, or vacuum by using piezoelectric scanners, optical lever deflection detectors, and very small cantilevers fabricated using photolithographic techniques. Because of their resolution and versatility, AFMs are important measurement devices in many diverse fields ranging from semiconductor manufacturing to biological research.

While AFMs are standard tools to measure nanoscale topography or nanomechanical and nano-electrical sample properties, infrared (IR) spectroscopy is another useful tool in many analytical fields such as polymer science and biology. Conventional IR spectroscopy and microscopy, however, have resolution on the scale of many microns, limited by optical diffraction. It has become apparent that it would be particularly useful to perform IR spectroscopy on a highly localized scale, on the order of biological organelles or smaller, at various points on a sample surface. That way, information about the composition of the sample, such as location of different materials or molecular structures, could be obtained.

Conventional far field infrared (IR) spectroscopy is a widely used technique to measure the characteristics of material. In many cases, the unique signatures of IR spectra can be used to identify unknown material. IR spectroscopy is performed on bulk samples which gives compositional information but not nanoscale structural information since, as just noted, IR spectroscopy allows collection of IR spectra with a limited resolution on the scale of many microns. Far-field localization techniques can achieve spatial resolution down to about 20 nm by point-spread function reconstruction but typically rely on fluorescence from discrete molecular or quantum dot emitters, with limited chemically specific information.

Scattering scanning near-field optical microscopy (s-SNOM) has been applied to some degree in infrared spectroscopy and imaging. In scattering-type SNOM (s-SNOM) external illumination of the sharp (metallic or semi-conducting) AFM probe tip leads to detectable light scattering from the near-field tip-sample interaction region-light scattering that is specific to the material under the tip. Alternative approaches such as coherent anti-Stokes Raman spectroscopy (CARS), or tip-enhanced Raman scattering (TERS) are also chemically sensitive but are also based on detection of scattered light from the sample.

Despite ongoing progress in the development of imaging techniques with spatial resolution beyond the diffraction limit, spectroscopic implementations delivering chemical specificity and sensitivity on the molecular level have remained challenging. What follows is a discussion of techniques that rely on mechanical detection of IR absorption in contrast to optical detection implemented, for example, in s-SNOM, CARS or TERS.

One technique based on use of an AFM to produce such localized spectra is described in a publication entitled “Local Infrared Microspectroscopy with Sub-wavelength Spatial Resolution with an Atomic Force Microscope Tip Used as a Photo-thermal Sensor” (PTIR) Optics Letters, 30, 2388-2390 (2005). The technique is also discussed in U.S. Pat. No. 8,402,819 (The '819 patent). Those skilled in the art will comprehend the details of the technique in the publication but the technique will be described briefly here for clarity. A more recent review of the AFM-IR techniques based on photothermal detection is given in Mathurin et al., Journal of Applied Physics, 2022, 131, 010901.

Referring to the '819 patent, in PTIR, infrared radiation is incident on a region of a sample. At a wavelength absorbed by the sample, the absorption will typically cause a local increase in temperature and a rapid thermal expansion of the sample. A probe is arranged to interact with the sample and transducer to generate a signal related to the absorbed IR energy in the region under the probe tip. “Interact” means positioning the probe tip close enough to the sample such that a probe response can be detected in response to absorption of IR radiation. For example, the interaction can be contact mode, tapping mode or non-contact mode. An associated detector can be used to read one or more probe responses to the absorbed radiation. The induced probe response may be a probe deflection, a resonant oscillation of the probe (flexural, torsional, lateral, etc.), and/or a thermal response of the probe (e.g., temperature change). For probe deflection and/or resonant oscillation of the probe, appropriate detectors can include an optical beam-bounce arrangement with split segment photodiodes along with any associated amplification and signal conditioning electronics. In the case of a thermal response, the appropriate detector may comprise, for example, a Wheatstone bridge, a current and/or voltage amplifier and/or other associated electronics to sense, amplify, and condition the thermal signal from the probe. The probe response is then measured as a function of the wavelength of incident radiation to create an absorption spectrum. From the spectra, material in the sample can be characterized and/or identified.

As noted in the '819 patent, an AFM set-up was used with a bottom-up illumination scheme where the sample is mounted on a ZnSe prism and the light is transmitted from below. A pulsed IR source, in this case a Free Electron Laser (FEL) beam, is directed into the prism and hits the sample at an angle where Total Internal Reflection occurs in order for the beam to be propagative in the sample and evanescent in the air. Thus, only the sample is significantly exposed to the laser radiation, and the AFM probe is minimally exposed to the beam. The probe is placed at a point on the sample by the scanner and is held at an average height by feedback electronics. Both the vertical and lateral deflection signal, as well as the feedback signal, may be monitored.

When the FEL is pulsed, the sample may absorb some of the energy, resulting in a fast thermal expansion of the sample as shown in FIG. 3 of the '819 patent. This has the effect of a quick shock to the cantilever arm, which, if the ability of the cantilever to respond to this shock is slower than the shock, will result in exciting a resonant oscillation in the cantilever. Because the absorbed energy is ideally contained within the sample, this shock is due primarily to rapid sample expansion, as minimal IR energy is absorbed by the cantilever itself. Although the probe is kept in contact with the surface by the feedback electronics, the resonant signal is too fast for the feedback electronics, but can be observed directly from the photodetector. Thus the cantilever rings down while still in contact with the surface, an effect called “contact resonance.” The absolute deflection, amplitude, and frequency characteristics of the contact resonance vary with the amount of absorption, as well as other properties, such as the local hardness, of the localized area around the probe tip, for example, by analyzing the ringdown and/or the Fourier transform (FFT) of the ringdown events. Also, depending on the direction of the expansion, vertical resonances, lateral or torsional resonances, or all the aforementioned resonances can be excited.

Resonance enhanced PTIR (also referred to as resonance enhanced AFM-IR, or resonance enhanced contact mode IR) is a recent method that provides improved signal levels and spatial resolution, as described in U.S. Pat. No. 8,869,602 and in publication Lu et al. “Tip-enhanced infrared nanospectroscopy via molecular expansion force detection”, Nature Photonics 8, 307 (2014). Improved sensitivity and spatial resolution are arguably achieved using field-enhancement at the AFM tip (as also present in s-SNOM or TERS) together with resonant excitation of a cantilever mode, e.g., a bending mode or a contact resonance mode. The latter may be achieved with an IR laser pulsing at the same frequency as the 2^{nd} cantilever bending mode while the AFM is operated in contact mode and photoexpansion is detected. A spatial resolution of 25 nm was observed, although only on ˜2 nm thin films. In addition, the films were deposited on an Au substrate, resulting in significant field enhancement in the substrate-tip cavity that is occupied by the sample. This scheme apparently requires substrate enhancement and hence limits its applicability to thin films that can be deposited on those substrates. Furthermore, AFM contact mode has severe drawbacks compared to intermittent contact (e.g., tapping) mode or peak force tapping mode in the form of tip/sample contamination, tip or sample wear and poor performance on soft, sticky or loose samples, all due to strong lateral forces during scanning, poor control of the deflection setpoint and lacking correction of any deflection drift once the probe is in contact with the sample. Especially tip contamination or tip wear may present a severe drawback here since any change in the tip geometry or surface influences the field distribution and field-enhancement at the apex. Another improvement came with the use of a bench-top QCL instead of an FEL which is a large user-facility laser. Other lasers such as optical parametric oscillators operating in the 2-10 micron wavelength range also became available to complement the 5-12 micron range of a typical QCL.

Another recently developed technique employing contact mode AFM operation is surface sensitive AFM-IR (U.S. Pat. Nos. 11,237,105, and 11,215,637, or Mathurin et al., Journal of Applied Physics, 2022, 131, 010901). The tip is mechanically oscillated on the surface in contact with the sample via modulation of the vertical sample position with scanner 24 in FIG. 1 or via modulation of the tip position with actuator 16. The frequency of this mechanically driven oscillation preferably overlaps with a contact resonance, usually at a higher frequency mode, although off-resonant drive is also possible. The light source repetition rate is tuned to the difference-frequency between the drive frequency of the mechanical oscillation and the detection frequency at which the laser-induced sample response is measured, which usually matches a lower probe contact resonance. Matching a probe resonance ensures signal amplification in the same way as in resonance enhanced AFM-IR. A benefit of surface sensitive AFM-IR over resonance enhanced AFM-IR is the reduced probing depth which means that the sample is probed closer to the surface with less bulk contribution.

Contact mode based AFM-IR techniques especially suffer from the sensitivity of the contact resonance frequency to the local tip-sample stiffness. That means that different sample locations show different contact resonance frequencies. As a consequence, resonance enhancement with its requirement to match the laser repetition rate to the contact resonance necessitates a frequency tracking mechanism. A phase-locked loop (PLL) is a common approach. An alternative has been described in Ramer et al. “Implementation of Resonance Tracking for Assuring Reliability in Resonance Enhanced Photothermal Infrared Spectroscopy and Imaging” Applied Spectroscopy. 71, 2013 (2017). It introduces a laser repetition rate chirp or sweep across the contact resonance to find and output the maximum IR signal within the sweep range.

To overcome the drawbacks associated with contact mode operation, tapping AFM-IR based on tapping mode operation (U.S. Pat. Nos. 10,228,388; 10,914,755) has been introduced. Here, the AFM oscillates the probe (with, for example, actuator 16 in FIG. 1) at one mechanical resonance of the cantilever (typically the 2^{nd} mode, in the 1400-1800 kHz range for a 40 N/m stiff probe) while IR detection is performed at a different cantilever mode (typically the 1st mode, around 250 kHz) with the IR laser tuned to the difference-frequency. Like PTIR, tapping AFM-IR detects a light-induced mechanical motion of the probe originating from photothermal expansion (e.g., Mathurin et al. Analyst, 2018, 143, 5940). Tapping AFM-IR reduces lateral forces compared to resonance enhanced AFM-IR, and also offers high sensitivity and lateral resolution below 10 nm. Currently, the requirement to match the laser frequency to the difference-frequency of certain cantilever modes limits the IR source to QCL lasers as in the case of resonance enhanced AFM-IR. Also, the cantilever modes may shift in frequency depending on the material under the tip, thus requiring a tracking mechanism for the frequency shift that adjusts the laser frequency accordingly, e.g., via a phase-locked loop (PLL). Photo-induced force microscopy (PiFM, U.S. Pat. No. 8,739,311) is a variant of tapping AFM-IR using the exact same experimental scheme of difference-frequency laser drive between a cantilever mode for tapping feedback and a second mode for detection of the light induced signal. However, while in tapping AFM-IR photoexpansion generates the light-induced signals, PiFM claims tip-sample dipole-dipole forces as the signal origin. This difference in signal origin is claimed to arise from the different AFM operating conditions: the repulsive regime for tapping AFM-IR and the attractive regime for PiFM. Both tapping AFM-IR and PiFM rely on resonant tapping, which as described below is in contrast to Peak Force Tapping® based IR modes where the probe oscillation typically occurs far below (at least 5×) the cantilever resonance.

In another technique, known as Peak Force IR and described in U.S. Pat. Nos. 8,955,161, 9,207,167, 9,719,916 and 10,520,426 which are expressly incorporated by reference herein, Peak Force Tapping® mode AFM is combined with directing light overhead of the sample and locally exciting the photothermal response at the tip-sample interface. The method identifies a change in modulus based on the directing step to provide an indicator of IR absorption by the sample. Measuring techniques sensitive to modulus change, such as peak force tapping (PFT) AFM mode, or contact resonance mode, may be employed.

The acronym Peak Force IR (PFIR) is more commonly referring to a more recent, related technique. PFIR is a peak force tapping-based method of AFM-IR where the IR laser induced sample response is detected during the PFT cycle so that chemical and nanomechanical information of the sample can be obtained. The principle of operation is described in U.S. Pat. No. 10,845,382 or more recently in Wang et al., Chem. Soc. Rev., 2022, 51, 5268-5286 or Mathurin et al., Journal of Applied Physics, 2022, 131, 010901. In short, when the laser pulse is absorbed by the sample during the tip-sample contact time within the PFT cycle, the cantilever deflection is modified, and this change is detected. Usually, this change is an oscillation or an offset in the deflection signal. Originally a single laser pulse in a first PFT cycle had been employed with no IR laser illumination for the subsequent cycle in order to remove the slowly varying cantilever deflection background by subtracting cycle two from cycle one. Later implementations (Wang et al., Nano Lett. 20, 3986, (2020)) removed the slowly-varying background via a fitting procedure before an FFT for signal extraction. A recent paper (Dorsa et al. Analyst, 2023, 148, 227-232) further improved the PFIR technique by using resonance enhanced IR detection with a gated Lock-in amplifier.

The aforementioned photothermal AFM-IR techniques inherit the benefits and drawbacks of the AFM mode they are based on. Tapping IR is ubiquitous but lacks force control and employs a nonlinear process for signal generation with the potential for nonlinearities in the IR absorption behavior. Resonance enhanced AFM-IR builds upon contact mode and hence suffers from large lateral forces during scanning, leading to tip wear and contamination, and prevents its use on soft, sticky and fragile samples such as nanoparticles or single molecules. Furthermore, in contact mode the force control is poor and prone to drift from, for example, small changes in the thermal environment. PF-IR reduces lateral forces and allows good peak force control, but during the PFT cycle the tip-sample forces are not constant but varying. In addition, the duty cycle, i.e., the time spent on the sample surface during a full PFT cycle, is limited. Hence, a nanoscale IR imaging and spectroscopy method is still desired that is based on linear signal generation, as in resonance enhanced AFM-IR, but with force control and the ability to keep the tip-sample interaction force constant while lateral forces are suppressed.

Lastly, we briefly describe another AFM mode relevant to the current invention. Force spectroscopy is a well-known AFM-based technique where the probe sample distance is varied in a controlled way by approaching and retracting the probe from the sample in a relative motion. A force-distance curve is measured in response, i.e., the deflection of the probe as function of the tip-sample distance, measured by the height sensor. Note that force curve typically refers to a force-distance curve but can also mean a force vs time representation (the force-distance curve follows then from the simultaneous height sensor vs time information). Here, we refer to force curve as force vs time. Such force spectroscopy has been used for a variety of experiments from pulling or stretching molecules to indenting sample surfaces.

In a typical force spectroscopy ramping operation, the tip and/or sample are moved relative to each other until a user-defined force or deflection trigger threshold is met that triggers the system to either change direction of the relative tip-sample movement or speed of motion, including a stopping movement. Alternatively, some other measured variable (amplitude, phase, deflection, current, deformation, lateral force, etc.) can be used as a trigger instead of force and “Z”, and/or another system controllable parameter may be adjusted (ramp at a different rate, move laterally to scratch, apply an electrical bias to tip or sample, change the drive amplitude or frequency, etc.). Such force spectroscopy performed at an array of pixels, i.e., at different xy sample locations, is commonly referred to as force volume or force volume mode.

The above summary of the prior art in AFM-IR underlines the need for additional advancements. Improvement is desired for broader adoption and better performance of AFM based IR techniques. As noted above, tracking of the cantilever resonance frequency, e.g., via a phase-locked loop (PLL), is often desired to maintain the condition of resonant AFM-IR signal enhancement on different sample materials. The preferred embodiments present an alternative to follow any material induced frequency shifts, and at the same time provide a more accurate approach to reveal the ‘true’ nanoscale chemistry without mechanical artifacts.

### SUMMARY OF THE INVENTION

Using force volume mode AFM, the preferred embodiments overcome the drawbacks of the prior art by using force control and the ability to keep the tip-sample interaction force constant while lateral forces are suppressed during horizontal probe positioning. The preferred embodiments illustrate a method employing force volume mode along with AFM-IR, sometimes referred to hereafter as FV AFM-IR. Note that while in AFM-IR using a tunable IR source is preferred, the preferred embodiments are not limited to using a tunable IR source. For instance, a broadband emitter (e.g., a laser-induced plasma, a globar, a synchrotron) could be employed as the light source, with appropriate supporting hardware.

FV AFM-IR maintains the benefit of resonance enhanced AFM-IR with its superior signal-to-noise and linear relation between laser repetition rate and induced IR response frequency. Furthermore, force volume based AFM-IR inherits another important advantage of force volume, namely its flexibility of creating a desired force profile in every force volume cycle or force curve, and its ability to combine AFM-IR measurements with nanoelectrical, nanomechanical and other measurements during the force curve.

In one preferred embodiment, an apparatus for characterizing sub-micron regions of a sample with an atomic force microscope (AFM) includes a z-scanner or piezo to move at least one of the probe and the sample to cause the probe of the AFM to interact with the sample in at least one approach segment, at least one hold segment with non-zero hold time and at least one retract segment. At least one controller controls the transient tip-sample interaction force during the at least one of an approach, hold and retract segment, and a light source is employed to illuminate the tip-sample region with light pulses to induce sample modifications. The apparatus also includes a detector to measure probe deflection due at least to the induced sample modification, and generate a signal corresponding to a light induced probe deflection change. The at least one controller extracts sample responses to the light pulses from the measured probe deflections. Corresponding methods are also disclosed.

In another aspect of this embodiment, the sample response is extracted at different positions on the sample, and the tunable light source is an IR light source. By using FV AFM-IR, the movement between different positions is free of lateral tip-sample interaction forces.

According to another aspect of this embodiment, the light induced probe deflection changes are vertical, horizontal, torsional, or a combination thereof.

According to a further feature of this embodiment, the light source is an infrared radiation source and the controller creates a spatially resolved map indicative of absorbed infrared radiation using the sample responses, and wherein the movement of the probe between sample positions is substantially free of lateral tip-sample interaction forces.

In another aspect of this embodiment, the at least one controller creates a spatially resolved map indicative of absorbed infrared radiation using the sample responses, and wherein the movement of the probe between sample positions is free of lateral tip-sample interaction forces.

In another feature of this embodiment, the sample responses are extracted with at least one of a resonance enhanced AFM-IR method, a surface sensitive AFM-IR method, a tapping AFM-IR method, a photo-induced force microscopy (PiFM) method, a peak force IR method and a torsional AFM-IR method.

According to a further aspect of this embodiment, the tip-sample interaction force during at least one hold segment is a pulling force.

In yet another aspect of this embodiment, the spatial resolution of the sample responses is sub-10 nm.

In this embodiment, the sample responses may be extracted for different wavelengths of the light source. In addition, the AFM, in at least one segment of the force curve, collects at least one of nano-mechanical and nano-electrical properties of the sample.

According to another aspect of this embodiment, the light source, in the at least one segment, illuminates the tip-sample region with light pulses at at least two pulse repetition rates. Moreover, the at least one controller, from the at least two sample responses to the light pulses at the at least two pulse repetition rates, determines elastic and viscoelastic sample properties.

In a further feature, in the at least one segment, at least one of the following parameters is changed: light source repetition rate, light source wavelength, light source power, light source pulse length, light source polarization, sample voltage, tip voltage, force, z position, and a ‘datacube’ is created with the sample response to the light illumination as function of selected parameters over a selected range.

According to another aspect of this embodiment, the at least one hold segment has a hold time below 100 seconds, and in some cases below 100 ms or less.

In other aspects of this embodiment, the sample responses are extracted at different repetition rates of the light source to control the probing depth. Moreover, the probe resonance shifts are compensated with a frequency tracking method. Note also that the techniques described herein can be used to measure samples in ambient and liquid environments.

In another embodiment, a method of characterizing sub-micron regions of a sample with an atomic force microscope (AFM) includes causing the probe of the AFM to interact with the sample in at least one approach segment, at least one hold segment with non-zero hold time and at least one retract segment by moving at least one of the probe and the sample. Then, the AFM controls the transient tip-sample interaction force during the at least one of the approach, hold and retract segments, and illuminates the tip-sample region with light pulses to induce sample modifications. Thereafter, probe deflection due at least to the induced sample modifications is measured and the method generates signals corresponding to the light induced probe deflection changes. Finally, sample responses to the light pulses from the measured probe deflection are extracted.

According to an additional aspect of this embodiment, the sample responses are extracted at different positions on the sample and wherein the movement between different positions is substantially free of lateral tip-sample interaction forces.

According to another aspect of this embodiment, in the at least one segment, the light source illuminates the tip-sample region with light pulses at at least two pulse repetition rates.

In a further aspect of this embodiment, the method extracts, from the light source repetition rate dependent sample responses, at least one of a surface pulse force, the sample absorption, the peak amplitude of the resonance, the Q-factor of the resonance, the full-width at half-maximum of the resonance, the peak amplitude of the resonance divided by the Q-factor, the center frequency of the resonance, the integral over the resonance, and the average value over the resonance.

In another aspect of this embodiment, the wavelength of the light source is swept to create a spectrum of the light-induced sample responses.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout, and in which:

FIG. 1 is a schematic illustration of a Prior Art atomic force microscope AFM;

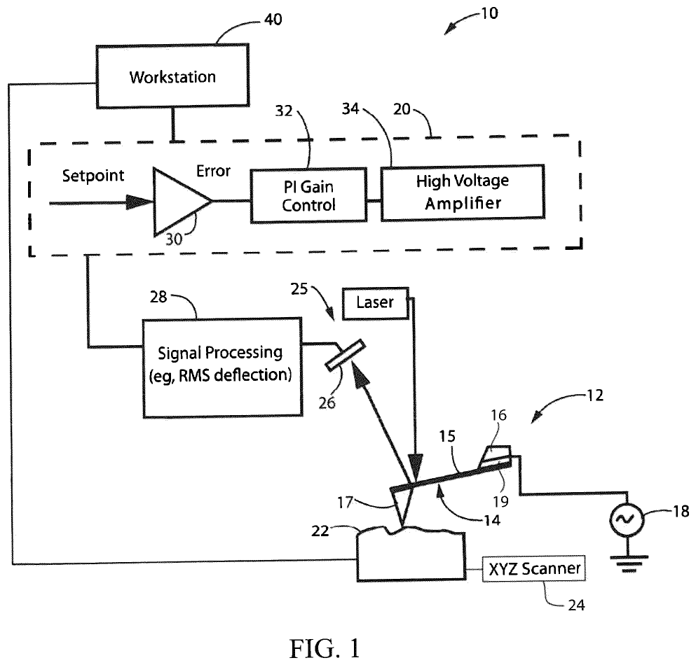

FIG. 2 is a schematic illustration of the set-up of the preferred embodiments;

FIG. 3 includes a plot of resonance amplitude as a function of the frequency, according to a preferred embodiment;

FIGS. 4A-4F include plots of the output of the present preferred embodiments using the light induced surface pulse force at multiple pulse repetition rates of the light source in resonance enhanced AFM-IR mode;

FIGS. 5A-D shows plots of other preferred embodiments, including sweeping the light source pulse repetition rate and band excitation;

FIG. 6 is a spectrum (different light source wavelengths) of nanoscale absorption shown for tapping AFM-IR, according to a preferred embodiment;

FIG. 7 is a flow chart illustrating methods of the preferred embodiments;

FIG. 8 is a schematic illustration of the force volume AFM-IR (FV AFM-IR) set-up of the preferred embodiments;

FIG. 9 includes plots of force volume deflection vs. time (force curve), with controlled probe-sample distance as measured by a height sensor, illustrating the laser-driven probe response during IR pulsing, according to a preferred embodiment;

FIG. 10 includes plots of force volume deflection vs. time (force curve), with controlled probe-sample distance as measured by a height sensor, illustrating the laser-driven probe response during IR pulsing, according to another preferred embodiment;

FIGS. 11A-11G are sample images of FV AFM-IR data, and plots of an FV AFM-IR force curve, IR amplitude and phase, and linecut IR absorption data, according to the preferred embodiments;

FIG. 12 is a plot of IR absorption vs wavelength using FV AFM-IR of the preferred embodiments, illustrating absorption peaks when sweeping the laser wavelength;

FIGS. 13A-G shows plots of an FV AFM-IR force curve and the resultant IR amplitude, along with the resulting images associated with a position dependent laser repetition rate sweep;

FIGS. 14A and 14B are plots of a force curve and an absorption resonance curve from a hold segment using ramp-scripting, respectively; and

FIG. 15 is a flow chart of FV AFM-IR methods of the preferred embodiments.

### DETAILED DESCRIPTION OF THE PREFERRED EMBODIMENTS

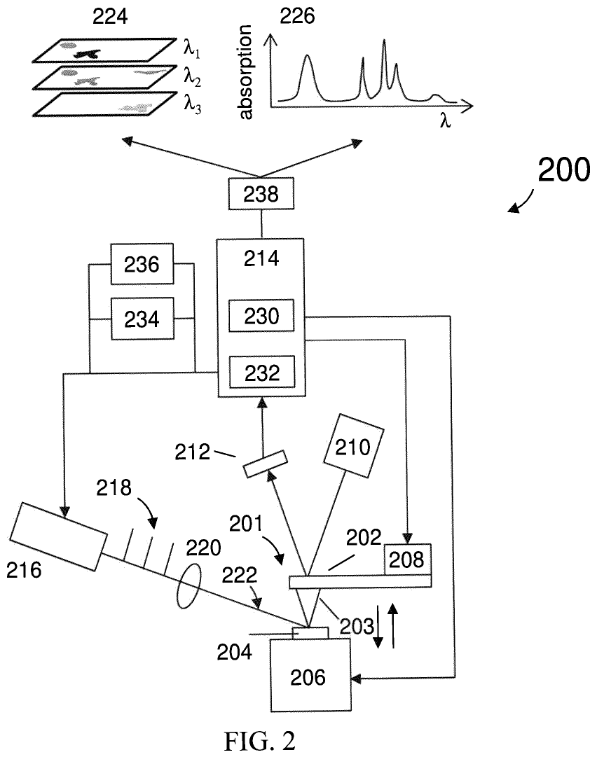

Turning to FIG. 2, the experimental setup 200 is described for an embodiment of the nanoscale spectroscopy invention. A probe 201 with a cantilever 202 that is terminated into a sharp tip 203 is engaged on a sample of interest 204. The IR probes 201 are preferably coated with metal such as Au or PtIr in order to provide field enhancement from the lightning rod effect and light localization under the tip 203. Sample 204 is mounted on a stage 206 of the atomic force microscope that includes a three-dimensional piezo scanner. A piezo 208 may be coupled to the cantilever 202. The sample stage 206 and/or the piezo 208, for example, provide a relative vertical motion between tip 203 and sample 204 while stage 206 can also deliver in-plane XY motion for sample scanning. The vertical deflection of probe 201 is detected using conventional beam-bounce optical detection with a diode laser 210 and a position sensor 212 (e.g., 4-quadrant photodetector). The vertical deflection is measured and routed to the controller 214 for AFM feedback, e.g., controller 214 controls the relative vertical position between tip 203 and sample 204 using at least one drive 230 within controller 214 (or separate) to control stage/xyz scanner 206 and/or piezo 208. As known in the art, the three-dimensional relative motion in xyz between tip 203 and sample 204 may be achieved by either moving the sample with xyz sample scanner 206, or the tip with piezo actuator 208 and additional xy-piezos, or by a combination of both tip and sample scanner piezos. The atomic force microscope controller 214 may be equipped with Peak Force Tapping® mode capability, as described for instance in U.S. Pat. No. 10,845,382, and may also operate in Force Volume mode, as described for instance in U.S. Pat. No. 9,910,064, also assigned to Bruker Nano, Inc.

The controller 214 also controls a frequency and wavelength tunable light source 216 using optics controller 232 of controller 214. Optics controller 232 may dictate the laser repetition rate, optionally assisted by an arbitrary waveform generator 234 and/or frequency mixer 236, and accept wavelength triggers in return from the light source, i.e., receive triggers corresponding to wavelength steps to correlate light-induced sample response data with wavelengths as required when acquiring wavelength-dependent spectra. It furthermore may set the light source wavelength, power, polarization, spectral width, pulse length, focus position or focus spot size, or other properties of the illumination. Controller 232 may also work together with or contain an arbitrary waveform generator 234 and/or frequency mixer 236 to provide a defined pulsing sequence to cause light source 216 to emit at multiple, well-defined pulsing or repetition rates, e.g., in the form of a band excitation over a range of repetition rates. Arbitrary waveform generator 234 can set the sequence of pulses with their pulse lengths, pulse intensities, pulse shapes and offsets between consecutive pulses. Frequency mixer 236 may be an electronic circuit or an equivalent means to mix frequencies to arrive at new frequencies, e.g., to derive in tapping AFM-IR from a probe oscillation frequency and the detection frequency for the infrared absorption signal the difference-frequency at which to pulse the laser (that mixing function may also be contained fully or in part within controller 214 or controller 232).

Light source 216 may provide a wide range of wavelengths from the UV to the far-infrared. In an alternative, light source 216 may be a broadband emitter, such as a laser-induced plasma, a globar, a synchrotron, etc. In one embodiment, source 216 provides infrared radiation (IR) that matches the vibrational resonances of molecules in the material under test, i.e., sample 204. Laser 216, such as a quantum cascade laser (e.g., MIRcat, Daylight Photonics) or an optical parametric oscillator (OPO), delivers laser pulses 218 at a frequency dictated by optics controller 232, optionally in combination with arbitrary waveform generator 234 and/or frequency mixer 236. This laser repetition rate can be chosen by the user, or is automatically adjusted, for instance in a phase-locked loop (PLL) as part of controller 214 in order to enable frequency tracking as described later. Or a certain shape for a repetition rate profile can be calculated by controller 214 and executed by an arbitrary waveform generator 234 to cause a band excitation over a repetition rate range. Or frequency mixer 236 may cause emission at only a few repetition rates, which can be used for instance in dual-frequency resonance tracking (DFRT) as explained later. The light beam 222 is focused onto the tip-sample region, i.e., the tip-sample interaction area, via a focusing element 220, e.g., a 25 mm focus length off-axis parabolic mirror, or any other optical focusing element such as a lens.

The light-induced sample response is sensed via deflection changes of probe 201 and is then associated with a sample position by controller 214. This is repeated at different sample positions and/or for different light wavelengths, e.g. in form of a continuous wavelength sweep. The resulting spatial scans 224 at different wavelengths (λ₁, λ₂, λ₃) and wavelength-dependent nanoscale localized spectra 226 indicative of IR absorption are then processed and displayed on a screen of a workstation 238 or saved as data by controller 214 or a workstation 238.

Preferably, the relative position between the focus of the infrared beam 222 and the tip 203 is constant during IR data acquisition, i.e., the optical alignment to the tip is unchanged during IR absorption mapping across the sample and during point spectroscopy at a fixed sample location. This ensures that during an IR scan of the surface at a single IR wavelength the light intensity at the tip-sample interaction region where surface modification occurs is constant so that the surface response to the IR light can be quantitatively compared at different locations.

In a different embodiment the IR laser spot may be much larger than the AFM scan area so that light intensity variations while scanning the probe relative to the IR illuminated spot may stay sufficiently constant during scanning, e.g., within 10%. As a result, IR data at different positions of probe 201 are only accurate to within 10% in this example since the laser power varies. In another embodiment the described effect of relative motion between probe and IR illumination area can be compensated. One way is to follow the probe position with the IR illumination spot during scanning. Another is to measure the spatial variation of the IR signal on a sample with a homogeneous IR response. Once the three-dimensional AFM-IR response is acquired for different xyz positions of probe 201 with respect to the IR illumination spot while the probe is in contact with the sample, measurements on other samples can be corrected for the spatial IR light variation.

Controller 214 or optics controller 232 contains a frequency generator to pulse laser source 216, or alternatively, the pulsing sequence can be created in combination with an arbitrary waveform generator 234 and/or frequency mixer 236. A QCL for instance allows pulsing that follows an applied TTL signal. Alternatively, the IR pulses can be selected within the laser output beam 222 via optical means under control of optics controller 232 (alternatively, combined with arbitrary waveform generator 234 and/or frequency mixer 236), e.g., by an acousto-optical modulator, electro-optical modulator, or a Pockels cell. A mechanical pulse picker (chopper) or rotating mirror can also be used to allow only selected pulses to pass towards the tip 203 while blocking unwanted pulses. It is understood that these elements may be inserted in the IR output of the IR light source, or they can be part of the IR light generation process within the laser system itself. In that case, for example, a Pockels cell may serve as a pulse selector to select the pump-laser pulses in an optical parametric oscillator or amplifier that drives the IR light generating process. What matters in the end is that tip 203 is irradiated with laser pulses at a pulse repetition rate controlled by optics controller 232, potentially with the help of waveform generator 234 and/or frequency mixer 236. The IR light beam 222 is linearly polarized along the tip 203 resulting in field enhancement at the apex of the typically conductive or metal-coated (e.g., PtIr, Pt, or Au) tip 203, a similar experimental condition as known for TERS or s-SNOM. Nonconductive tips and perpendicular light polarization with respect to tip 203 result in reduced signal.

Changes in the vertical deflection of the probe (or in the lateral, horizontal or torsional deflection) are typically analyzed in real-time with a lock-in amplifier. A lock-in amplifier is a physical device and/or an algorithm that demodulates the response of a system at a reference frequency. Lock-in amplifiers may be electronic assemblies that include analog electronics, digital electronics, and combinations of the two. They may also be computational algorithms implemented on digital electronic devices like microprocessors, field programmable gate arrays (FPGAs), digital signal processors (DSPs), and personal computers. A lock-in amplifier analyzes an oscillatory system and outputs different signals, including amplitude, phase, in phase (X) and quadrature (Y) components or any combination thereof. The lock-in amplifier in this context can also produce such measurements at both the reference frequency and higher harmonics of the reference frequency.

Note that the light-induced probe deflection changes (e.g., in response to light-induced sample modifications) in a preferred embodiment of the invention is originating from a photothermal expansion, i.e., light absorption, local sample heating and local sample expansion leading to a surface pulse force detected by the AFM probe. In other embodiments, the light induced surface pulse force may for instance originate from a local sample compression after light absorption, or from softening or hardening of the sample with changes in modulus, stiffness or adhesion. In addition to these mechanical property changes, the surface pulse force may be caused by electromagnetic forces, for example, from light induced dipole forces (as, e.g., claimed as the driving forces in PiFM), charge accumulation, charge displacement, charge oscillation such as in plasmons or phonon polaritons, or sample polarization. While light absorption with photothermal expansion is most common in the infrared spectral region, other wavelength ranges from the ultraviolet (UV) to the far-infrared (e.g., terahertz) may exhibit different physical phenomena such as plasmon excitation in the visible or near-infrared that may all cause detectable changes in the AFM probe deflection.

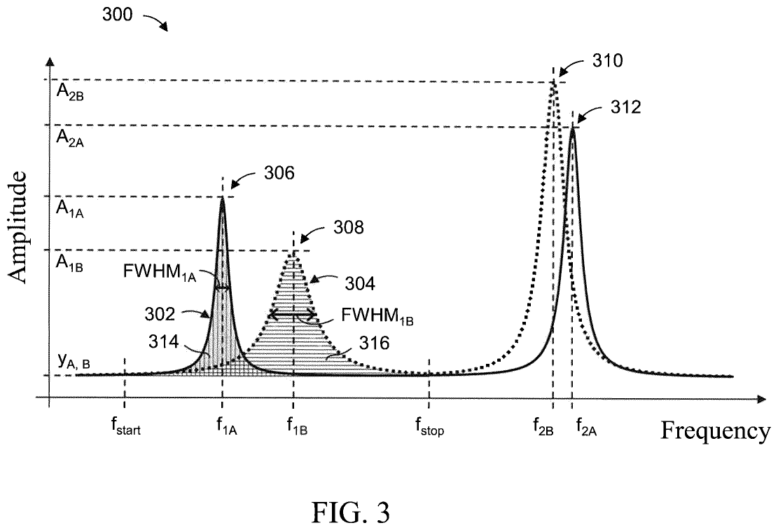

In FIG. 3 we turn to a plot of the resonances 300 of probe 201 and cantilever 202, relevant for the current preferred embodiments. The plot depicts the resonance amplitude as function of the frequency. The resonances displayed in FIG. 3 can be obtained in different ways. They can be excited mechanically, for instance via a piezo actuator 208 driving the cantilever 202 or sample scanner 206 oscillating the sample 204 under the tip 203, while sweeping the drive frequency, i.e., for instance increasing the frequency with time from a start value while detecting the probe deflection amplitude (and phase) with a Lock-In amplifier locked to the changing drive frequency. Optical excitation in a photothermal drive of the cantilever 202 is also possible, in which the cantilever and not the sample absorbs the usually visible radiation leading to a photothermally induced cantilever bending (not to be confused with the AFM-IR photothermal effect in the sample under the tip 203). In thermal tune, the same plot can be obtained: the deflection spectrum is then analyzed via a Fast Fourier Transform (FFT) of the time-domain deflection data without an active mechanical (or photothermal) drive. Random cantilever movement is more pronounced at the probe resonances, thus delivering a similar spectrum of the probe resonance eigenmodes. Note that a mechanical, active drive of the cantilever may also distort the resonance spectrum since it is now convoluted with the frequency-dependent efficiency of the drive mechanism and its coupling to the cantilever. Most importantly, the probe eigenmodes can be excited via the light induced sample modifications, i.e., the probe can be driven into oscillations at its eigenfrequencies by the light-induced surface pulse force, e.g., from photothermal sample expansion after infrared light absorption (induced sample modifications). In that case the light source repetition rate is continuously or discretely increased (or decreased) from a start value while the probe deflection is simultaneously analyzed for instance with a Lock-In amplifier with the changing light source repetition rate as reference frequency. FIG. 3 represents then resonant behavior of probe mediated detection of the infrared sample response: an increased IR induced sample response is observed at the probe resonance eigenmodes while the signal drops for off-resonant light source pulsing. Note that an FFT of the time-domain deflection data during the repetition rate sweep delivers the same data and is an alternative to a Lock-In amplifier.

Although representative for many different types of resonances of the probe as explained later in more detail, the probe resonances 300 are discussed here for resonance enhanced AFM-IR. In this case the probe is in contact with the sample and the resonance plot 302 shows two contact resonance eigenmode peaks 306 and 312 on sample material ‘A’. Typically, the line shape of the peaks can be approximated by a Lorentzian that is characterized for peak 306 by a center frequency f_{1A}, a peak amplitude A_{1A}, a full width at half maximum FWHM_{1A} and a baseline offset y_{A} from zero. Other derived quantities may be used as well, e.g. the quality or Q-factor Q_{1A}=f_{1A}/FWHM_{1A}. But in general, four quantities such as peak height or peak amplitude, width (FWHM, 1/e2, D4σ, or other line shape width representations), center frequency and baseline offset describe a Lorentzian shaped resonance.

Moving to a material ‘B’ on the sample may change the resonance curve from 302 on material ‘A’ into dotted curve 304 on material ‘B’. On material ‘B’ different sample properties such as for instance stiffness, adhesion and damping can shift the resonance from a center frequency f_{1A} to f_{1B}. A change in peak height from A_{1A} to A_{1B} may follow and might also be accompanied by a change in FWHM from FWHM_{1A} to FWHM_{1B}. Not all resonances need to behave in the same way so that for instance a second, higher resonance might shift in center frequency in the opposite direction, i.e., from peak 312 with higher frequency f_{2A} to a lower frequency f_{2B} for peak 310, a shift opposite to the resonance peak shift of the lower resonance from 306 to 308.

The resonance curves 302 and 304 of FIG. 3 were introduced for resonance enhanced AFM-IR that is based on AFM operation in contact mode. However, such probe resonances appear in the measured light-induced sample response for all AFM-IR modes that employ resonance enhancement. In a tapping AFM-IR implementation, the probe is mechanically oscillated (e.g. via piezo 208), or via a photothermal drive, at a free-air probe resonance, for instance at the second probe resonance 312 at a frequency f_{2A}. Detection of the light induced surface pulse force then occurs at the lower resonance peak 306 at frequency f_{1A} while the light source, usually a laser, is pulsing at the difference frequency f_{2A}−f_{1A}. On a sample, at typical tapping AFM-IR settings, the resonances do not shift as much as in contact mode and stay close to the free-air resonances. But frequency shifts still occur for both involved frequencies, and line shape changes such as broadening and peak amplitude reduction. Photo-induced force microscopy (PiFM) can practically be regarded as Tapping AFM-IR so that the same explanation applies, although the light-induced surface pulse force may originate from tip-sample dipole-dipole forces under certain conditions.

In another AFM-IR variant the effect of the light-induced surface pulse force is corrected for artifacts by a mechanical motion or oscillation of either the sample via sample scanner 206 or piezo 208 coupled to probe 201 (U.S. Pat. No. 11,143,672). The effect of the surface pulse force can even be compensated or cancelled in a closed-loop feedback this way. Again, the same plot 300 of probe resonances applies for the resonant probe excitation, even if that excitation is now effectively suppressed and the signal indicative of the light-induced surface pulse force is derived from the drive signal necessary to mechanically oscillate the probe to suppress the light-induced signal. Surface sensitive AFM-IR uses a similar excitation scheme as Tapping AFM-IR, however, again in contact mode as in resonance enhanced AFM-IR. A resonance such as 312 would be driven mechanically (e.g. via piezo 208 or sample stage 206) while another resonance such as 306 would be used for IR detection with the laser pulsing again at the difference frequency. In Peak Force IR with resonance enhanced IR detection (Dorsa et al. Analyst, 2023, 148, 227-232) resonance curve 302 would also represent the probe's contact resonances. Hence, FIG. 3 relates to many different AFM-IR modes. Furthermore, such resonances where the probe is forced into oscillation by the light induced surface pulse force can be observed and employed in the vertical deflection, but also in horizontal or torsional deflection, or a combination thereof, so that the resonances can for instance represent flexural or torsional eigenmodes in contact or non-contact modes (i.e., contact resonances or close to free resonances). Note that only two resonances were shown but usually many more exist, for instance, a soft 0.2 N/m probe for resonance enhanced AFM-IR can reveal 8 or more contact resonances below 3 MHz.

A light-induced surface pulse force, e.g., a photothermal sample expansion from infrared light absorption, is usually sensed from a deflection change as the peak amplitude of the probe resonance, for instance as amplitude A_{1A} on material ‘A’ for the resonance peak 306 in FIG. 3, usually with the help of a Lock-In amplifier. Off-resonant detection is also possible, i.e., signal extraction at a lower amplitude than the peak value. Importantly, such signal is in any case obtained at a single frequency of the laser pulse rate. Since the probe resonances in general shift in resonance frequency on different materials due to mechanical property changes, such a frequency shift is usually followed or tracked, for instance with the help of a phase-locked loop (PLL) that maintains a certain phase value. However, the light-induced signal readout would still occur at a single frequency. On material ‘A’ a signal A_{1A} might be recorded in imaging or spectroscopy at a certain light wavelength while on material ‘B’ a lower signal A_{1B} is measured even with an active PLL that correctly followed the center frequency of the peak 306 to peak 308. A change of the peak shape, in this example a broadening from FWHM_{1A} to FWHM_{1B} is notably not entering the detected signal, independent of whether a frequency-tracking method such as a PLL is used or not. The problem with that approach and the fix in the current invention is discussed in the following.

In the current invention the light-induced surface pulse force is not sensed at a single pulse repetition rate of the light source but integrated over a resonance of the probe, e.g. obtained from a repetition rate sweep. For curve 302 on material ‘A’, such integration over the first resonance peak 306 is highlighted as dark shaded area 314 with vertical stripes under the curve. Integration here is performed over a frequency range from a frequency start fₛₜₐᵣₜ to a frequency stop fₛₜₒₚ, a range that fully contains the resonance and covers the maximum shift of the resonance for all probed materials, here ‘A’ and ‘B’. Note that for the area under the curve the offset y_{A} or y_{B} has been subtracted before integration or summation over the resonance peaks. For the specific example here, the integral 314 under peak 306 is now smaller than the integral 316 under peak 308. This contrast between materials ‘A’ and ‘B’ in the light-induced response from integration is now inverted from the contrast obtained from just the peak amplitudes A_{1A} and A_{1B}, i.e., while resonance peak 308 is smaller than peak 306, resonance peak 308 is much broader. Integration takes resonance broadening from increased damping into account while any readout at a single frequency does not.

The probe acts as a detector to sense the light induced surface pulse force. The surface pulse force is caused by for instance an oscillating photothermal expansion of the sample (i.e., induced sample modifications) which is detected by the probe and typically amplified at one of the probe's resonances. The probe responds over the resonance curve, i.e., not just at a single frequency but over a typically Lorentzian line profile with a FWHM proportional to damping or inversely proportional to the Q-factor. In that sense the probe's resonance represents the probe's response function.

The higher the damping, the broader the resonance and the frequency range over which the probe can detect, but the less effective the detection at a single frequency. Integration over the resonance line shape ensures that the photothermal expansion is detected over all frequencies over which the specific probe resonance is sensitive and can be excited efficiently. In one interpretation, this integral is proportional to the energy in the laser induced surface expansion and hence to the sample absorption. The amplitude at a fixed frequency usually measured with a Lock-In amplifier analyzing the probe deflection is proportional to the sample's thermal expansion which is in turn proportional to the sample's absorbance. When operating on or near resonance, the amplitude depends on both (i.e., is proportional to the absorbance and the Q-factor of the resonance).

The integral over the Lorentzian shaped line profile (also applicable for other possible resonance line profiles like a Gaussian), after offset or baseline removal, is proportional to the peak amplitude times the full width at half maximum FWHM, thus, to peak amplitude times resonance frequency over Q-factor, or to peak amplitude over Q-factor when neglecting resonance frequency shifts. Hence, obtaining the signal (representing the light-induced surface pulse force) from the integration over the resonance sweep basically measures the peak height usually detected at a single fixed frequency with or without a PLL-based approach but now normalized by the Q-factor. In other words, the detected sample absorption by the probe is proportional to the area under the resonance curve, namely peak amplitude over Q-factor, while single-frequency detection in the art with or without a PLL only captures the peak amplitude, not accounting for the broad probe detector response. This normalization by the Q-factor ensures that the extracted light-induced surface pulse force is now substantially independent of damping. As an example, for two materials ‘A’ and ‘B’ of the same absorbance the damping on ‘B’ may be twice the one on ‘A’ (Q-factor on ‘B’ is then half of ‘A’). The peak amplitude on ‘B’ would be half the one on ‘A’ and known measurements of the peak amplitude alone would conclude that ‘A’ absorbs twice as strongly as ‘B’. The integrals over the resonance line shapes on ‘A’ and ‘B’ however would be identical. Hence, a surface pulse force derived from the integral over the resonance line shape would measure the correct absorption properties of ‘A’ and ‘B.’ The surface pulse force would not convolute absorption and damping any more but would be independent of damping. Note that averaging over the frequency sweep range is equivalent to integration, except for a constant factor of the integration length.

The necessity to normalize the peak amplitude by the Q-factor may also follow from a different point of view. The probe amplifies, by its Q-factor, the signal of the surface pulse force. Hence, from the measured signal, the amplification factor Q needs to be removed so that the surface pulse force is now independent of Q and is thus a more accurate representation of the IR absorption. The point is that in order to measure this force, the current preferred embodiments, in contrast to known methods, do take the whole line shape of the probe resonance, and specifically its width, into account.

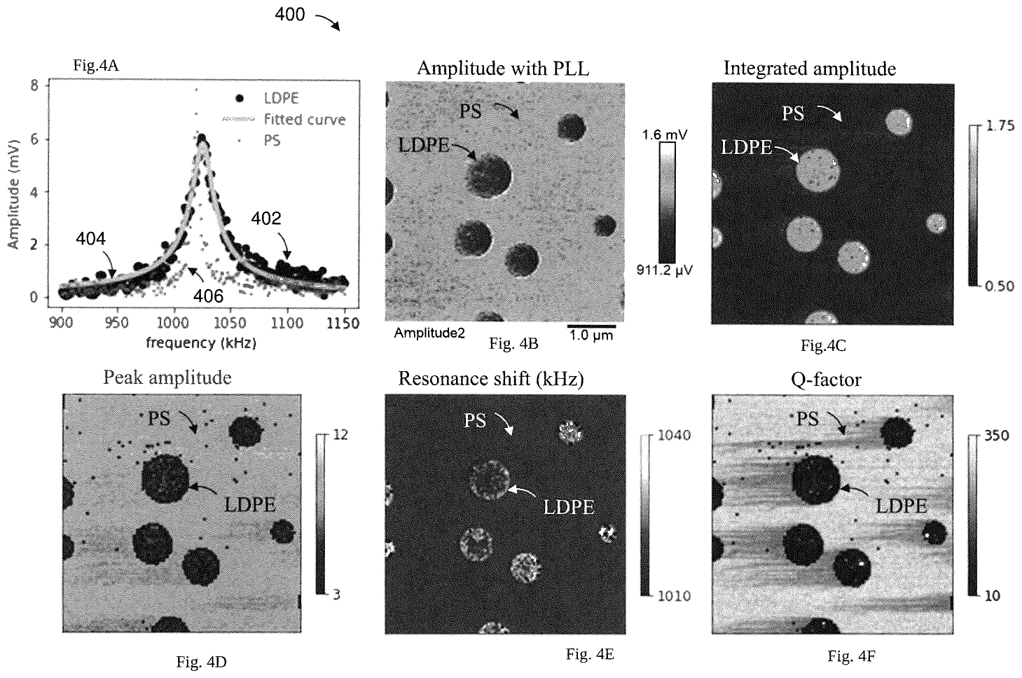

As an example, in FIG. 4 a soft (0.2 N/m) gold-coated probe was used on a PS-LDPE sample to demonstrate the present preferred embodiments using resonance enhanced AFM-IR. A 128×128 pixel image was obtained with a measurement time less than 90 min (e.g., 85 min) in contact mode and in each pixel the laser repetition rate was swept from 50 kHz to 3300 kHz within a 300 ms period before advancing to the next pixel of the image. The wavenumber was fixed at 1463 cm−1 corresponding to an LDPE absorption. While the full resonance frequency sweep contains at least eight (8) contact resonances for this specific probe, FIG. 4 concentrates on only a single of these probe resonance eigenmodes, namely the one around 1000 kHz. Note that a frequency sweep or multi-frequency excitation (simultaneous light source emission at different repetition rates) over such a single probe resonance can be taken within, for example, 100 ms, 10 ms or 1 ms per pixel (depending on desired signal-to-noise ratio). FIG. 4A shows the infrared absorption signal extracted around this resonance between 900 kHz and 1150 kHz, for two locations on the sample. The data taken on LDPE (402, large dots) is fitted with a Lorentzian line shape (404, full line). For comparison, the resonance on PS (406, small dots) is much narrower, shows a small frequency shift towards lower frequencies and exhibits a larger peak amplitude of around 8 mV at the contact resonance compared to 6 mV on LDPE. These specific values of peak amplitude as well as full width at half maximum, center frequency and baseline or offset can be obtained from fitting with a line shape function such as a Lorentzian. Such fitting can be executed at each pixel of the xy sample scan to extract nano-absorption and other information.

In FIG. 4B a measurement on the same sample is shown for the routinely employed resonance enhanced AFM-IR technique where nano-IR absorption data is obtained from the Lock-In amplifier output near or at the probe resonance. A PLL is used to follow any contact resonance shifts during scanning, locally adjusting the laser repetition rate from pixel to pixel while the Lock-In amplifier demodulates the probe deflection at this local frequency. For the given wavenumber of 1463 cm−1, dark LDPE beads are embedded in a bright, higher-signal PS matrix. This contrast is unexpected since the chosen wavenumber is an absorption of LDPE but not of PS, so that the PS matrix should be darker than the LDPE beads. In comparison, FIG. 4C displays the integration of the resonance enhanced AFM-IR signal over the contact resonance curves after fitting data such as 402 and 406 as displayed in FIG. 4A with Lorentzian line shapes 404. At each xy location on the sample, the Lorentzian fit of the AFM-IR signal has been integrated from 900 kHz to 1150 kHz within the full 50-3300 kHz sweep. In the resulting image the LDPE beads within the PS matrix now exhibit a larger absorption than the matrix, as expected at this infrared wavenumber tuned to an LDPE absorption. The contrast between LDPE and PS is inverted in FIG. 4C for the AFM-IR signal integrated over a laser repetition rate range compared to the usually obtained peak amplitude at a single frequency in FIG. 4B. This behavior highlights the benefit of the invention: for some samples, even frequency tracking with a PLL (FIG. 4B) does not fully remove mechanical artifacts due to different sample material properties.

Taking the whole line shape into account, i.e., not only frequency shifts that a PLL would also track, but also broadening from damping, via for instance integration over the contact resonance as in FIG. 4C, reveals a sample response where the light-induced surface pulse force is independent of damping and at the same time with a contrast between sample components that matches the expectation and is hence closer to the ‘true’ chemistry of the probed sample. Note that not all samples show such a pronounced effect as for the presented PS-LDPE sample with its large change in modulus and damping between components. Often samples show similar damping between constituents so that material contrasts obtained using a PLL for frequency tracking would resemble the ‘true’ chemistry, at least qualitatively. This may help explain why incorporating damping into the analysis of the light induced surface pulse force has not been applied yet.

FIG. 4A already illustrates the difference between the data treatment of FIGS. 4B and 4C and why a different contrast results. PS 406 in FIG. 4A has a larger peak amplitude at the contact resonance (8 mV) than LDPE 402 (6 mV). But since the resonance curve for LDPE 402 is much broader, the integral over the displayed frequency range is much larger for LDPE than for PS.

Besides delivering the correct light-induced sample response, the frequency sweep also provides additional valuable sample information that helps in data interpretation. The Lorentzian line shape fitting 404 depicted in FIG. 4A extracts for instance a peak amplitude at the fitted contact resonance, plotted at each xy location on the sample in FIG. 4D. This image matches FIG. 4B in contrast, i.e., LDPE beads exhibit less absorption than the surrounding PS matrix. In fact, in both cases FIGS. 4B and 4D the peak amplitude is shown since the PLL-based frequency tracking extracts exactly that, the signal amplitude at the local contact resonance peak (assuming that the PLL was set to maintain the phase value at maximum amplitude). Furthermore, the local contact resonance frequencies (center frequencies of the Lorentzian fits) can be obtained in FIG. 4E. Here, LDPE shows a slightly higher resonance than the PS matrix. The full-width at half maximum or the Q-factor are another quantity that follows from such fitting.

The LDPE beads in FIG. 4F are characterized by a lower Q-factor, here by a factor of up to 5-6 times lower than the one of the PS matrix. Again, this large broadening or damping of the resonance in the tip-sample interaction is not captured in known techniques, whether or not mechanical artifacts are partially compensated by frequency-tracking with a PLL, since only a single amplitude value of the resonance curve (e.g., the peak) is recorded at a single laser repetition rate. Integration over the resonance curve or other means to take the line shape or Q-factor into account give a more correct representation of the light-induced sample modification. As an example, plotting the peak amplitude divided by the Q-factor gives a similar image as the integrated amplitude of FIG. 4C. In fact, for a Lorentzian or Gaussian line shape the integral under the curve is proportional to the peak amplitude times the FWHM, or peak amplitude times resonance frequency divided by the Q-factor (i.e., peak amplitude divided by the Q-factor when neglecting frequency shifts).

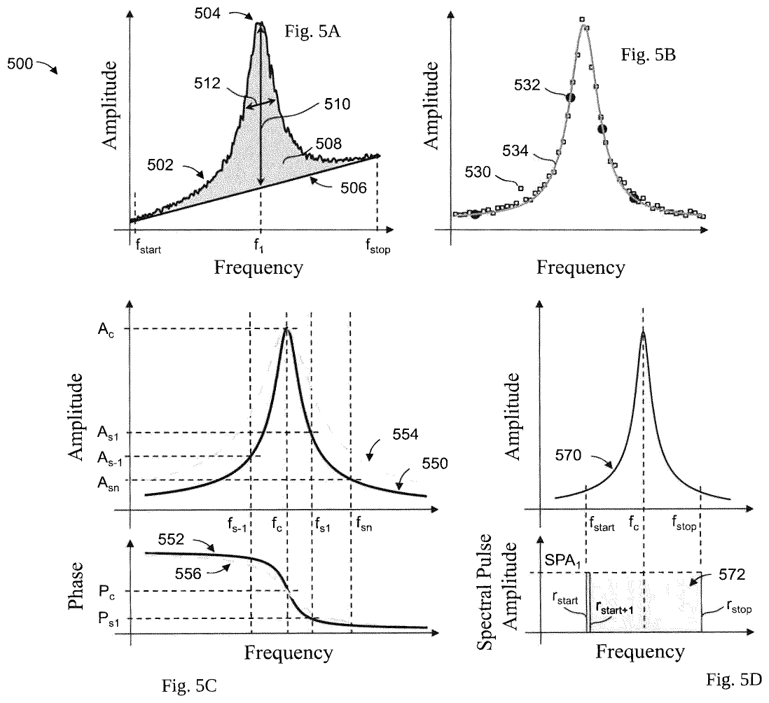

In FIG. 5 we turn to some other embodiments of the invention. In FIG. 5A a resonance 502 is shown with a peak at 504, obtained, for example, by sweeping the light source (e.g., laser) pulse repetition rate in a single xy pixel on the sample and simultaneously recording the Lock-In amplifier amplitude signal of the probe deflection. The resonance displays a vertical offset that is not constant over the displayed frequency range. In that case it is preferred to approximate the baseline with a linear fit 506, subtract that fit from the resonance curve, and then integrate (or sum discretely) over the resulting line shape between frequency boundaries fₛₜₐᵣₜ and fₛₜₒₚ to arrive at area 508 under the resonance curve. Alternatively, instead of an integration or sum, a peak amplitude 510 above the baseline and FWHM 512 can be obtained from a line shape fit (e.g., a Lorentzian or Gaussian or other suited shape). The signal of interest indicative of the light-induced surface pulse force is then obtained as either the integral/sum 508 under the curve or as the product of peak amplitude 510 and FWHM 512. Note that the average value of the frequency dependent amplitudes of the resonance curve is the same as the integral/sum under the curve normalized by the number of data points, and hence also represents the surface pulse force.

Instead of a linear background as depicted in FIG. 5A other background shapes are possible, e.g., a polynomial one or an oscillatory background, that can then be fitted by a polynomial or a sin function before removing such background from the resonance curve 502. Such offset or background does not need to be removed, integration/summation or fitting may be applied directly without background removal. In that case however, the signal contribution of the light-induced surface pulse force might be small in case of a large background with a small resonance curve 502 on top of such a background. Similarly, it is preferred to integrate/sum over a substantial part of the resonance, i.e., fₛₜₐᵣₜ and fₛₜₒₚ are distanced away from the peak center frequency f₁ far enough so that the resonance curve 502 has decayed substantially, e.g., to only 1% of the peak amplitude 510. Limiting the integration range or the fitting for a line shape fit to frequencies where the amplitude of the resonance curve 502 after background subtraction is at least 5% of the peak amplitude 510, or even 50%, is possible. However, the closer fₛₜₐᵣₜ and fₛₜₒₚ get to the center frequency f₁, the more inaccurate a line shape fit gets. In case of signal integration/summation, narrow integration boundaries would less and less capture the width of the resonance, i.e., damping and line broadening so that the benefit of measuring over the probe response function incorporating multiple laser repetition frequencies compared to only a single laser repetition rate as in the art gets smaller.

Note that for signal integration/summation over a resonance, the resonance curve such as 502 does not need to be fitted to a line shape first. Discrete summation of the laser repetition rate dependent amplitudes over the resonance is also possible and saves the step of line shape fitting.

Furthermore, in another embodiment the presented integration/summation and also the line shape fitting (with or without a background/offset removal) to obtain peak amplitude, FWHM or Q-factor and derived from that the area under the curve is not limited to a single resonance but can also be applied to multiple resonances. FIG. 3 displayed two resonances 306 and 312 in resonance curve 302 for which the described methods could be applied, e.g., in form of a broad laser repetition rate sweep covering both resonances 306 and 312 with signal summation/integration over both resonances to derive a signal for the light-induced surface pulse force.

In another embodiment, as illustrated in FIG. 5B, the resolution or spacing between data points at which the resonance curve in a frequency sweep at a single xy sample location is acquired can vary greatly. While 2000 data points may have been displayed in FIG. 5A for curve 502 with a resolution of 10 Hz for a 130 kHz resonance with 3 kHz FWHM, other acquisition and sampling parameters are possible, also depending on the probe resonance eigenmode frequency. In FIG. 5B a discrete sampling at data points 530 (open squares) is shown together with an even lower sampling of four data points 532 (full dots). In the latter case of four data points, a Lorentzian fit 534 reasonably matches the higher sampled data as well, i.e., approximates the probe resonance line shape quite well. As data points 532 also highlight, a sampling at equal frequency intervals is not required either. If extraction of the signal of the light-induced surface pulse force is desired via fitting with a line shape function such as a Lorentzian, four data points (i.e., amplitude-frequency-pairs) are in principle sufficient to find the four fit coefficients of peak amplitude, FWHM (or another representative of width such as 1/e2 diameter or D4σ), center frequency and offset. If the offset is assumed to stay largely unchanged when scanning over different xy locations on the sample, it may also be measured only once and then be fixed in the line shape fitting routines. However, in practice, also with the additional noise of any data measurement system, good line shape fitting results require more than 4 data points per resonance, or a thoughtful selection of the acquisition points. For instance, acquiring four data points close to the maximum amplitude of the resonance may result in an accurate fit of the peak amplitude and the center frequency but may not be able to capture the FWHM and the offset. On the other hand, data points spaced too far apart may capture well an offset in a line shape fitting but might not be able to find any peak above the offset.

Other embodiments are discussed based on FIG. 5C with an idealized measured probe resonance in amplitude 550 and phase 552, as obtained for instance by a Lock-In amplifier or a Fast-Fourier Transform of the time-domain probe deflection. As discussed with respect to frequency sweeping or stepping in FIGS. 5A and 5B, multiple measurement points are needed across the resonance for accurate fitting of the amplitude 550. The number of necessary data points can be reduced however, e.g., if the center frequency f_{c} and peak amplitude A_{c} at the center frequency is known. A phase-locked loop (PLL) is traditionally used to follow any resonance shift by maintaining a fixed phase relation to keep the light source repetition rate within the resonance of the probe, preferably exactly on resonance to maximize resonance enhancement (here, by maintaining phase setpoint P_{c} for phase 552, for example, which tracks the frequency to overlap with the center frequency f_{c} of the resonance 550). Consequently, employing a PLL for resonance tracking can deliver f_{c} and the peak amplitude A_{c}. Instead of stepping the light source repetition rate to measure the deflection amplitude signal at other frequencies, the light source may be modulated to emit at multiple pulse rates simultaneously, e.g., at a frequency fₛ₁, fₛ₂ . . . fₛₙ at which the probe deflection signal may be obtained with the help of a Lock-In amplifier with multiple demodulators to record amplitudes Aₛ₁, Aₛ₂, . . . . Aₛₙ.

Depending on the experimental conditions, there may be a minimum of data pairs (amplitudes extracted at defined frequencies) necessary for accurate line shape fitting. For example, if the offset or background can be assumed to be negligible, or it is a constant offset during the measurement and determined once, knowing the center frequency f_{c} and the corresponding deflection peak amplitude A_{c}, as well as a single additional data pair of frequency fₛ₁ and amplitude Aₛ₁ may be sufficient to fit to a line shape function, especially since a mirror symmetry can be assumed, i.e., the line shape is symmetric around the center frequency f_{c} and every measurement at frequency fₛₙ gives a corresponding data point at fₛ₋ₙ=f_{c}−(fₛₙ−f_{c}) with the same amplitude Aₛ₋ₙ=Aₛₙ. It is preferred to measure the amplitude A at the at least two frequencies f that are offset from the center frequency f_{c} of the resonance by less than two times the full width at half maximum of the resonance, even more preferred by less than one time the full width at half maximum. This ensures resonance enhancement of the light-induced sample response signal as well as good fitting of the data points to a line shape.

Such simultaneous light source emission at different repetition rates may be obtained by frequency mixing to drive the light source, e.g., a quantum cascade laser, at multiple frequencies. A frequency mixer such as 236 may obtain the center frequency f_{c} from a PLL and a second frequency fₘ to create a sideband frequency fₛ₁=f_{c}+fₘ (or another linear combination of these frequencies) which is also fed to the light source to emit now at f_{c} and fₛ₁. Alternatively, and less practical, multiple light sources may be used and their emission overlapped at the tip-sample region (e.g., with the help of a beam combiner, or focusing the beams on the tip from different directions), each light source with a different pulse repetition rate.

While the center frequency f_{c} can be determined with a PLL, other methods to achieve the same are also possible. Similar to dual-frequency resonance tracking (DFRT), the light source can be modulated at fₛ₁ and fₛ₋₁, conveniently generated as sideband frequencies around a to-be-determined center frequency f_{c} with fₛ₁=f_{c}+fₘ and fₛ₋₁=f_{c}−fₘ where fₘ is a fixed frequency for mixing. Such frequency generation can be achieved with a frequency mixer. The difference between amplitudes Aₛ₁ and Aₛ₋₁ (each e.g., demodulated with a Lock-In amplifier) is only zero for a symmetric line shape if both frequencies fₛ₁ and fₛ₋₁ are symmetrically positioned around a center frequency f_{c}, i.e., the amplitude difference Aₛ₁−Aₛ₋₁ can be used as an error signal to find center frequency f_{c}. Note that applying DFRT alone is not sufficient to extract a line shape for further IR signal extraction since only a center frequency f_{c} and two amplitude-frequency data pairs Aₛ₁ at fₛ₁ and Aₛ₋₁ at fₛ₋₁ are provided. At least another amplitude-frequency data pair is necessary, or the peak amplitude at the center frequency f_{c}.

A PLL or DFRT may have problems to lock on a signal if the signal-to-noise ratio is small in amplitude and phase. A small light-induced sample response is possible, e.g., if the sample absorption is small at the chosen light source wavelength. Mechanically exciting the probe resonance eigenmode via sample scanner 206 and/or piezo actuator 208 while tracking resonance shifts with a PLL feedback on this mechanical drive may allow more accurate determination of the center frequency for low signal-to-noise ratio conditions (see EP 3,722,817). This is feasible for a PLL-based tracking but also in a DFRT-approach where the sample or probe would be mechanically actuated at two sideband frequencies around the thus-to-be-determined center frequency f_{c} of the resonance.

Note that in one embodiment, the symmetry of the line shape around the center frequency is used to simplify or reduce subsequent or concurrent measurements. For instance, collecting data only on the left- or right-hand side of the resonance around the center frequency is sufficient compared to measuring on both sides. This also applies for sweeping/stepping over the resonance, i.e., after finding the center frequency f_{c} through a method such as a PLL- or DFRT-based tracking approach, stepping the repetition rate to either cover only repetition rates larger than the center frequency f_{c} or small than f_{c} may be sufficient to extract the full line shape due to the symmetry of the resonance around the center frequency. Such an approach of stepping/sweeping over only half of the resonance saves measurement time.

The signal extraction discussed in FIG. 5 including line shape fitting and signal summation/integration over the resonance is applicable independent of the origin of the resonance or the AFM operational mode. Whether the resonance is observed in vertical, horizontal, torsional or a combination of these deflections, or whether the AFM operational mode is contact mode or peak force tapping or Force Volume, where the resonances are contact resonances, or tapping, non-contact or PiFM in which the resonances are closer to free-air eigenmodes, the signal extraction of FIG. 5 applies. A combination of methods is possible too, for instance, the center frequency f_{c} may be found with a PLL based on the light induced deflection change while a repetition rate sweep or discrete stepping across the resonance may be conducted, and while a mechanical drive of the sample or the probe (via sample scanner 206 or probe piezo 208) compensates exactly the light-induced deflection change as in U.S. Pat. No. 11,143,672.

Since the oscillating probe on the sample, forced into oscillation by the surface pulse force, may be described with a damped harmonic oscillator model, any increase in damping and line broadening in amplitude (e.g., from amplitude curve 550 to a two times broader dashed curve 554) is reflected as well in a corresponding change in phase (here from phase 552 to dashed curve 556). That means instead of deriving the light-induced surface pulse force signal entirely from the amplitude curve 550 or 554, it can be obtained partially from the phase response 552 or 556 as well. For example, the center frequency f_{c} and a line width parameter proportional to the amplitude FWHM may be extracted from the phase 552 or 556, while the resonance peak amplitude A_{c} does not follow from a phase measurement. Similarly, instead of analyzing the amplitude and phase output of a Lock-In amplifier or FFT routine, other equivalent outputs such as in-phase and quadrature amplitudes deliver the same information from which a signal indicative of the light-induced sample modification can be derived. Furthermore, while a Lorentzian line shape fits the resonance amplitude quite well, other line shape functions such as a Gaussian, Voigt or Doppler profile may be used for fitting and signal extraction. Alternatively, more complicated line shape functions may be used, e.g., derived from modeling the tip-sample interaction (a damped harmonic oscillator model is one example of such a model).

Another embodiment using such modeling follows the idea of DART (dual AC resonance tracking, e.g., Gannepalli et al. Nanotechnology 22, 355705 (2011)) that is used in piezoresponse force microscopy. Here, the light source would be modulated at two frequencies f₁ and f₂ that surround the center frequency f_{c} of the resonance with a fixed frequency difference Δf=f₁−f₂ that is on the order of the FWHM. The amplitudes and phases at these two frequencies are assessed while a feedback loop keeps the amplitude difference at zero by varying f₁. This ensures that the resonance frequency f_{c} is centered between the two frequencies f₁ and f₂ in the same way as in DFRT. With the four measured quantities of amplitudes and phases, fitting to a driven damped oscillator model reveals at least center frequency f_{c}, Q-factor and peak amplitude from which the IR light induced surface pulse force can be extracted as peak amplitude over Q-factor. Other techniques developed for a mechanical sample actuator such as scanning probe resonance image tracking electronics (SPRITE, e.g. Kos et al. Kos et al. Meas. Sci. Technol. 25, 025405 (2014)) can be adopted to a light induced sample actuation also.

Above techniques of DART or SPRITE are known in the context of contact resonance imaging. Replacing the mechanical actuator of these techniques with light induced sample excitation to obtain the contact resonance line shape with at least the contact resonance frequency f_{c} and the Q-factor enables the same nanomechanical property extraction. Specifically, elastic sample properties such as stiffness and viscoelastic properties of storage and loss moduli and loss tangent can be accessed with knowledge of the free resonances of the probe when not in contact with the sample. The latter may be obtained by thermal tune spectra, or sweeps from a mechanical drive via a piezo, a photothermal cantilever drive (usually in the optical or near-infrared, not to be confused with photothermal AFM-IR), or also from light illumination in photothermal AFM-IR (e.g, in the infrared) using for instance absorption in the cantilever base material or its coating to induce a cantilever response. Such elastic and viscoelastic property measurement via e.g. IR sample absorption based excitation of the probe resonance in contact mode, force volume, tapping or peak force tapping may provide benefits over the common mechanical sample actuation, e.g. operation does not require a sample piezo actuator and hence can be applied to any IR absorbing sample. A weakness of this method is that the extracted elastic/viscoelastic properties may be affected by the concurrent local sample heating.

Another embodiment is sketched in FIG. 5D where band excitation is used to excite a substantial part of the probe resonance response function 570 with a defined ‘band’ of laser repetition rate frequencies 572. The frequency band 572 (grey area) consists of laser pulses covering a start frequency rₛₜₐᵣₜ to a stop frequency rₛₜₒₚ with a constant spectral pulse amplitude SPA₁ for each covered light-source repetition rate in between. For instance, the frequency band 572 may be 10 kHz wide containing 100 pulse repetition rates at 100 Hz spacing and centered around the center frequency f_{c} of the resonance curve 570. The band excitation spectrum 572 is associated with a defined time-domain pulse sequence of the light source. The pulse sequence may originate from an arbitrary waveform generator 234 to drive the light source in a defined sequence of pulses with defined pulse lengths, pulse shapes, pulse amplitudes and pulse separations according to a model. Band excitation in AFM (U.S. Pat. No. 9,097,738) is an established method to mechanically excite the probe cantilever over a frequency band and hence the procedure can be adapted for the light-induced surface pulse force to drive the cantilever with a desired light source pulse repetition rate excitation spectrum. Note that arbitrary spectral band excitation profiles 572 are possible, i.e., the spectral pulse amplitude SPA does not need to be constant over the frequency range so that the spectrum 572 may resemble for instance a Lorentzian line shape as well instead of the displayed ‘box’ in the example of FIG. 5D. Furthermore, symmetry of the resonance 570 can be employed again, so that the excitation band may not be centered around f_{c}, but could mainly cover the resonance portion above or below f_{c}.

When the probe is excited simultaneously over the frequency band 572 the resulting deflection change can be recorded via an FFT of the time domain deflection data or a Lock-In amplifier. The latter may require multiple demodulators to cover the frequency range and from the individually recorded amplitude, the line shape of the resonance 570 can be reconstructed for evaluation, or the output of the demodulators may be summed directly to represent the light-induced sample modification signal. Alternatively, the Lock-In amplifier bandwidth may be increased to allow broadband detection equivalent to an integration over the resonance curve 570. Furthermore, the scheme presented in U.S. Pat. No. 11,143,672 may be applied here as well, i.e., the light induced deflection change after band excitation may also be corrected or suppressed by a band excitation of a mechanical drive of the probe or sample so that for instance the mechanical drive signal now delivers the desired light-induced sample response.

In another embodiment the line shape of the employed probe resonance can be determined without using a light source. The tip could be excited mechanically into an oscillation using piezo actuator 208 or sample scanner 206 (or similar means, e.g., a thermal tune (U.S. Pat. No. 8,680,467), or photothermal drive of the cantilever, not to be confused with the AFM-IR photothermal effect in the sample). A frequency sweep of piezo actuation while recording the probe oscillation amplitude would lead to a resonance curve such as 550 in FIG. 5C, from which for instance the full width at half maximum FWHM can be obtained. To approximate the light induced surface pulse force, the light induced probe deflection change would need to be measured also, but now it is sufficient to do so for only a single light source repetition rate, here, at or near the center frequency f_{c} of the resonance peak 550 of FIG. 5C. With the knowledge of this measured light induced peak amplitude A_{c} at frequency f_{c} the integral under the resonance peak 550 can be approximated as peak amplitude A_{c} times FWHM. In this embodiment, the peak amplitude A_{c} would have been obtained from measuring the light induced on-resonance probe deflection change, e.g., a laser driven photothermal sample expansion, while the FWHM would come from a Lorentzian line shape fit of the resonance as measured by, for example, a thermal tune, or a piezo actuator sweep, i.e., by means that do not involve the light source (the light source may still be emitting and illuminating the tip-sample region but it is not used to measure the FWHM). DART or SPRITE using a piezo actuation would be other examples of techniques to obtain line shape properties such as the FWHM. This assumes that the probe resonance line shape determined with light illumination is similar to the one determined by other means than light illumination.

While in the described embodiment it is preferred to operate the light source at the center frequency of the probe resonance, an off-resonant repetition rate is also possible. Then the light induced signal amplitude is below the peak amplitude A_{c}, but the latter can be extrapolated from the resonance line shape obtained without light illumination. As an example, suppose the laser repetition rate was tuned to a frequency fₛ₁ in FIG. 5C and an amplitude Aₛ₁ was measured under laser illumination. If the measured piezo actuator driven peak amplitude at frequency f_{c} was three times the measured piezo driven resonance amplitude at the same frequency fₛ₁, the same ratio would apply between the laser induced peak amplitude A_{c} at frequency f_{c} and the measured laser induced amplitude Aₛ₁ at frequency fₛ₁, so that the latter would need to be scaled by a factor of three to arrive at the light induced peak amplitude A_{c}. Similar to the scheme presented in U.S. Pat. No. 11,143,672, the piezo driven deflection change at frequency fₛ₁ may be tuned in drive amplitude and phase to suppress the light induced deflection change. After this ‘calibration’ at frequency fₛ₁, the piezo driven peak amplitude at frequency f_{c} matches the light induced one A_{c}. In summary, it is possible to deduce a light induced peak amplitude A_{c} of the probe resonance from a measurement with light illumination at a single repetition rate, even if it was off-resonant, but it needs to be combined with a measurement of the probe resonance by other means than light illumination of the tip-sample region. The surface pulse force is then obtained as described before, e.g. as the product of peak amplitude times FWHM, or peak amplitude normalized by the Q-factor to make it independent of damping. Note that determining the probe resonance with means other than illuminating the tip-sample region is fast: rapid frequency sweeps (e.g., with a piezo actuator) may be performed within 0.5 ms to 100 ms, which might offer speed benefits over other ways to measure the resonance curve such as rapid thermal tunes (see, e.g., US '467 patent).

As explained previously, sweeping the light-source repetition rate or discretely stepping it across the probe resonance, or simultaneously pulsing the light source at multiple repetition rates to integrate or sum over the resonance peak, or in order to allow fitting to a line shape function with subsequent integration or area calculation (e.g., via peak amplitude times FWHM), results in a data point representing the light-induced surface pulse force. In the case of imaging, such signal extraction at each xy sample location delivers, for instance, infrared nanoscale absorption maps at a single wavelength such as in FIG. 4C, including sub-10 nm spatial resolution mapping for certain AFM-IR techniques such as tapping AFM-IR. However, the same procedures can be repeated for different light source wavelengths to arrive at a spectrum of the sample response.

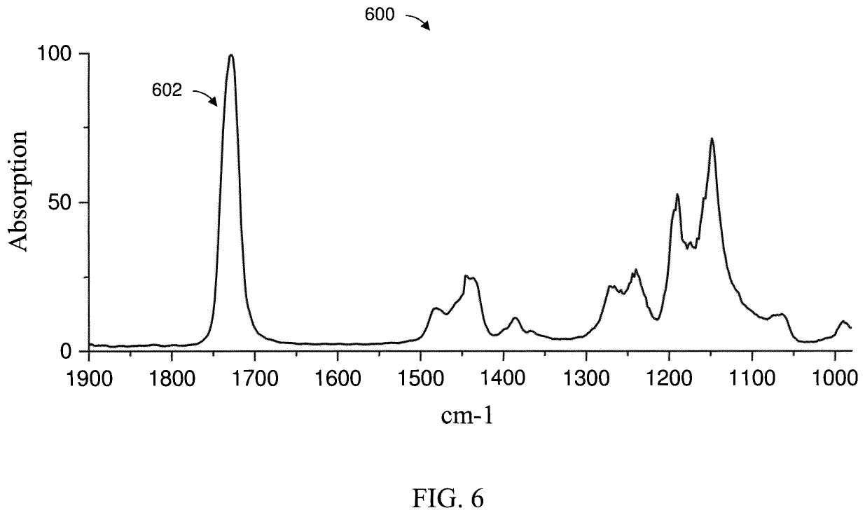

In FIG. 6 such a spectrum is shown for tapping AFM-IR. A stiff probe (40 N/m) was driven at its second eigenmode (1575 kHz) while the infrared absorption was detected using the probe's first eigenmode at 250 kHz. Traditionally each spectral point in the wavelength sweep represents the amplitude output of a Lock-In amplifier while an infrared laser is pulsed at a fixed repetition rate matching the frequency difference between the second eigenmode used for AFM feedback and the first eigenmode employed for infrared signal detection with the Lock-In amplifier (heterodyne detection scheme where the excitation frequency differs from the detection frequency). A PLL may also be enabled during the sweep to follow this resonance. Here, in the current invention a 5 ms long repetition rate sweep has been performed for each wavelength step in the following way. A Lock-In amplifier demodulated the probe deflection at the difference frequency between the second eigenmode at which the AFM feedback is operated (1575 kHz) and the laser repetition rate (1325 kHz). Sweeping the laser repetition rate during a 5 ms long period also sweeps the demodulation frequency of the Lock-In amplifier over the probe's first eigenmode (˜250 kHz). Integration over the obtained resonance curve delivers a datapoint at a given wavelength before the procedure is repeated at the next wavelength step. The resulting infrared absorption spectrum over the ˜1000-1900 cm⁻¹ fingerprint spectral region on the PMMA sample reveals distinct PMMA absorption lines such as the carbonyl resonance 602.

As discussed before, this method of extracting the light-induced sample response from a repetition rate sweep over a resonance curve or from simultaneous pulsing of the light source at multiple repetition rates offers advantages over a PLL-based frequency tracking approach, where the latter may work imperfectly at low light-induced signals, or for fast and large resonance frequency shifts. For instance, while acquiring a wavelength-dependent spectrum (such as in FIG. 6) small signals regularly occur since materials seldom absorb everywhere over the entire probed spectral range. That means that there are wavelengths over a wavelength scan where the signal drops substantially (e.g., at 1600 cm⁻¹ in FIG. 6) and a PLL has difficulties to find a resonance, or only finds it with some delay. Recording a pulse repetition rate sweep at each wavelength step on the other hand ensures that the correct contact resonance has been covered, even if the signal was weak. Furthermore, if two contact resonances are close together, a PLL could also jump between adjacent resonances and create an undesired, ill-defined mixture of sample responses intermittently probed at two resonances. Employing a frequency sweep approach may also show both resonances but they can be distinguished in post-processing, or can be integrated over, while a PLL can only follow one. These benefits of a frequency sweep apply to imaging as well.

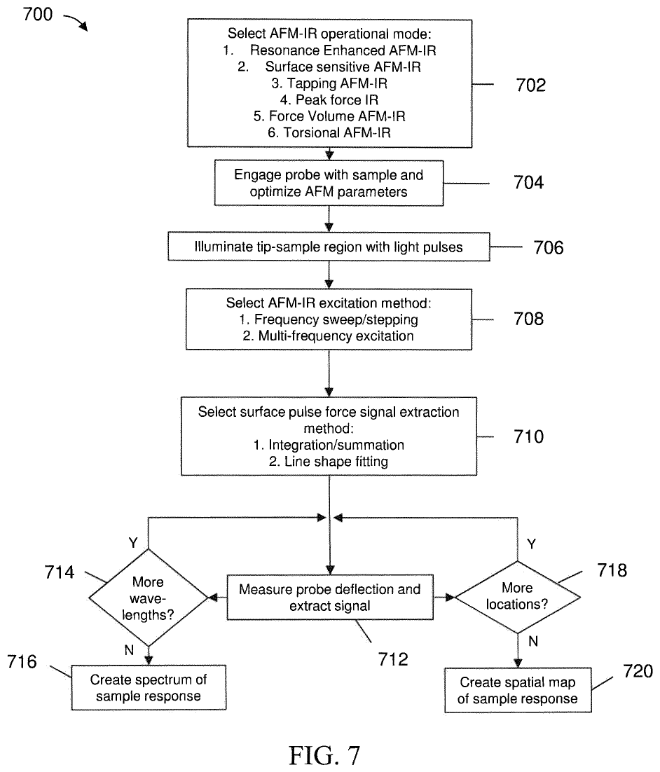

Some of the preferred embodiments are displayed in the flow chart 700 in FIG. 7. First, in Step 702 the AFM operational mode is chosen. If based on contact mode AFM operation, these options may be resonance enhanced AFM-IR and surface sensitive AFM-IR. Tapping AFM-IR is based on tapping mode. Photo-induced force microscopy (PiFM) is a variant of Tapping AFM-IR, claimed to operate in a slightly different AFM parameter space. In another variant the infrared induced sample response may be suppressed in closed-loop feedback by a mechanically driven oscillation (U.S. Pat. No. 11,143,672). Other AFM-IR modes to select from comprise Peak Force tapping based Peak Force IR and Force Volume AFM-IR which is explained here in much more detail. Furthermore, the probe resonances for all AFM-IR modes may be detected in vertical deflection, horizontal or torsional deflection, or, as a combination thereof. Specifically, torsional resonances may be employed in torsional based AFM-IR.

In torsional AFM-IR the feedback control signal is not based on a flexural deflection of the cantilever probe as in tapping, contact or peak force tapping AFM, for instance. Instead, a torsional amplitude (or phase) from a horizontal probe actuation parallel to the surface enters as the feedback signal. Such torsional AFM operation is combined with IR illumination for torsional AFM-IR. For instance, the probe is modulated (e.g., via a piezo actuator 208) near or at a torsional resonance of the cantilever with torsional amplitude (or phase) as the feedback control parameter. The light-source is pulsing at a repetition rate overlapping with another torsional of flexural resonance (homodyne scheme) and thus excites a light induced surface pulse force whose magnitude is extracted from the deflection. Similarly, heterodyne detection such as usually employed in tapping AFM-IR can also be used in torsional AFM-IR, e.g., to drive a torsional eigenmode at one frequency for AFM feedback and detect the light-induced sample modifications at a second torsional (or flexural) eigenmode with a light source pulse repetition rate tuned to the difference frequency of the two involved eigenmodes (or more generally, to a linear combination of the two eigenmode frequencies including also the sum frequency or mixing between harmonics).

Other variants exist where the AFM feedback is not employing a torsional resonance, but where torsional resonances take part in the AFM-IR signal generation process. For example, the probe may be operated in tapping AFM, i.e., the cantilever is oscillated at a flexural mode and its amplitude or phase is used for feedback, while IR signal detection happens at a torsional eigenmode, either in heterodyne detection with the light source pulsing at the difference frequency, or in homodyne detection where the light source pulse repetition rate directly overlaps with the torsional eigenmode. As another example, in Peak Force Tapping with its feedback on force (or deflection), the light induced surface pulse force may be excited at a torsional mode with the laser pulsing at this torsional eigenmode (homodyne). Or, still in PFT, in a heterodyne detection scheme a torsional or flexural eigenmode is excited, for example, mechanically with a piezo actuator 208, while the light induced surface pulse force is read at a different torsional or flexural eigenmode and the light source is pulsing at a repetition rate tuned to a linear combination of the involved eigenmodes, e.g., at the difference frequency.

In Step 704 the probe is engaged with the sample surface and AFM parameters are optimized according to standard practices. Next, in Step 706 light pulses are focused on the tip-sample region and parameters such as light intensity and wavelength are optimized. In Step 708 the AFM-IR excitation method is chosen as either frequency (i.e., repetition rate) sweeping or simultaneous multi-frequency (multiple repetition rate) excitation. In frequency sweeping or stepping, the light-source repetition rate is stepped while recording the light-induced change in the probe's deflection preferably across a probe resonance for each repetition rate step. In multi-frequency excitation the light source is driven to emit at several pulse repetition rates simultaneously. A frequency generator, frequency mixer or arbitrary waveform generator may provide such electronic signals to cause the light source to emit in a specific pulse sequence with defined pulse lengths, pulse amplitudes, pulse separations and pulse shapes or polarizations, in order to cause a defined excitation spectrum that can range from at least two excitation frequencies up to a certain shape of broader band excitation.

Next, in Step 710, the method to extract the light induced surface pulse force is chosen before in Step 712 the deflection is measured and the signal is extracted. Having recorded several data points of amplitude versus frequency over the probe resonance in Step 708, the data can be summed or integrated (or averaged) after optional removal of a baseline or offset. Such signal treatment may be realized by summing or averaging the output of several demodulators of a Lock-In amplifier with each demodulator probing a different excitation frequency (or detection frequency, which differs from the excitation frequency for heterodyne schemes such as tapping AFM-IR). Another option is to use a large bandwidth for a single demodulator and thus covering a band excitation. Yet another implementation may be based on an FFT of time-domain deflection data obtained during multi-frequency excitation or a frequency sweep. The obtained frequency spectrum of the probe resonance or of multiple resonances can then be integrated or averaged. In yet another embodiment the deflection data is analyzed in the time-domain, e.g., to deduce the light induced probe oscillation amplitude (at different light source repetition rates) from signal rectification, boxcar averaging and other methods.

Another extraction method in Step 710 uses line shape fitting of the probe resonance after acquisition with a Lock-In amplifier or after treatment of the time-domain data for instance with an FFT. Suitable line shape functions such as a Lorentzian may be applied after optional removal of an offset or baseline. The probe resonance shape may also be approximated by a suitable model such as a damped harmonic oscillator. Parameters resulting from such fitting typically include the peak amplitude, center frequency, full width at half maximum and offset. The light induced surface pulse force can then be extracted from either an integration over the fitted line shape or from parameters proportional to the integral or area under the curve, e.g., peak amplitude times full width at half maximum, or peak amplitude normalized by the Q-factor. Note that the light induced resonance curves can also serve to extract nanomechanical sample properties, elastic and viscoelastic ones.

Once the sample response has been extracted, optionally with the help of PLL- or DFRT-methods (or DART, or SPRITE for instance), Step 712 can be repeated to collect sample responses at more wavelengths of the light source, a choice taken in Step 714. The resulting spectrum of sample responses as a function of wavelength may be created in Step 716, representing in a preferred embodiment an infrared absorption spectrum after normalization by the wavelength-dependent laser power. Alternatively, the wavelength can be kept constant while changing the sample locations in 718 and repeating Step 712. In such a case, a spatial map can be created in Step 720 to indicate position-dependent infrared absorption, for instance. It is also possible to combine Steps 716 and 720 to create hyperspectral data: a spatial map that contains position-dependent spectra.

Note that a frequency sweep or a simultaneous multi-frequency excitation does not necessarily mean that the light source repetition rate matches the probe resonance that is used to extract the light induced sample response. This only applies to some AFM-IR modes such as resonance enhanced AFM-IR or Force Volume AFM-IR where a laser repetition rate sweep or multiple pulse repetition rate excitation generally overlaps with a probe resonance. That means the light induced signal is excited and extracted at the laser repetition rate, for instance with the help of a Lock-In amplifier with the laser repetition rate serving as the Lock-In amplifier reference frequency. Many examples before were explained in this context with an AFM-IR mode, such as resonance enhanced AFM-IR, in mind. Even in these modes it is also possible to set the laser repetition rate to a fraction of the probe resonance frequency, i.e., ½, ⅓, ¼ . . . 1/n with integer n, and still excite the probe resonance. In heterodyne schemes such as in surface sensitive AFM-IR or tapping AFM-IR, the light source repetition rate usually does not match a probe resonance frequency (with the exception that tapping AFM-IR has a homodyne version as well). Only when mixed with another frequency such as the drive frequency from drive 230 of piezo actuator 208 in tapping AFM-IR (or surface sensitive AFM-IR), the resulting frequency, here piezo drive frequency minus laser repetition rate, overlaps substantially with a probe resonance for signal enhancement. Other linear combinations of drive frequency, laser repetition rate and probe resonance frequency are possible as well.

In these cases of frequency mixing the light induced sample response is extracted at a detection frequency other than the light source pulse repetition rate, e.g., again with a Lock-In amplifier whose reference frequency is now for instance given by the difference frequency of piezo actuator 208 oscillation frequency and laser repetition rate. However, the frequency at which the light-induced signal is extracted is always related to the light source pulse repetition rate, either directly in a 1:1 correspondence for homodyne schemes, or via frequency mixing with other frequencies such as a piezo actuator drive frequency in heterodyne schemes. Consequently, a light source frequency sweep or simultaneous pulsing at multiple repetition rates, always results in a frequency sweep or simultaneous excitation at the same detection frequencies, or at detection frequencies that are offset and related to the repetition rate by frequency mixing in a linear combination of repetition rate with other frequencies.

Note that in general there is more than one probe resonance so that multiple resonance peaks such as 306 and 312 in FIG. 3 would be observable depending on the chosen frequency range in both a mechanically driven sweep (using, for example, a piezo actuator to induce a probe oscillation), or an optical one (where the infrared laser is swept in repetition rate). The availability of multiple probe resonances is valuable in itself, especially in an IR absorption measurement, i.e., when originating from an optical photothermal excitation. In one embodiment of the current invention, an IR-induced frequency spectrum as curve 302 can be obtained over a large laser repetition rate range on each pixel of a sample, for a single laser wavelength or a full IR absorption spectrum over several wavelengths. IR absorption images can then be calculated from that data set for each laser repetition rate, i.e., one could obtain an IR absorption image at the absorption wavelength of one component of the sample for multiple resonance frequencies of the probe. It is known (U.S. Pat. No. 11,237,105) that an increased IR pulse repetition rate leads to a smaller thermal diffusion length and hence to a higher spatial resolution that also limits the sensitivity to closer to the top layer of the sample. In contrast, a lower repetition rate is associated with a larger diffusion length (larger probing depth) and hence a lower spatial resolution. The photothermal signal is then less confined to the surface and originates more from regions deeper under the sample surface. As a consequence, obtaining IR images or spectra for different laser repetition rates allows to adjust the probing depth and obtain depth information of the sample, i.e., provides a way to study the vertical composition of the sample and distinguish and identify deeper layers from layers closer to the top surface. This can be applied to all AFM-IR modes, specifically to the surface sensitive IR mode (U.S. Pat. Nos. 11,237,105 and 11,215,637).

It is understood that in alternative embodiments, the wavelength region can be extended beyond the infrared of the preferred embodiment, for example to the ultraviolet, visible, near-infrared and terahertz or far-infrared spectral region. QCLs and optical parametric oscillators (OPOs) exist as pulsed and modulated light sources in the infrared. The UV, visible and near-IR is covered by laser sources such as solid state lasers, fiber lasers, diode lasers, optical parametric oscillators or gas lasers, as well as laser sources based on nonlinear frequency conversion comprising optical parametric generation, sum-frequency generation, harmonic generation, frequency combs and related methods. In the terahertz spectral region terahertz quantum cascade lasers are emerging, while terahertz gas lasers, terahertz antennas or free-electron lasers already exist to cover that range. In the extended wavelength range from UV to terahertz, the surface pulse force during laser pulsing can originate from several effects. In the terahertz region plasmon polaritons in graphene or cooper pair polaritons in superconductors exist that may induce an electromagnetic force between probe and sample under light excitation from charge redistribution and charge oscillation. Another example is phonon resonances leading to absorption and photo-expansion in the terahertz range. In the UV, visible and near-infrared range plasmonic resonances, e.g., in metal nanostructures, exist, absorbing energy for photo-expansion or altering electromagnetic fields through their charge oscillation or charge redistribution, thereby exerting a surface pulse force on the probe.

Such laser sources may not only emit narrowband, but also broadband. Broadband sources comprise large user-facilities such as a synchrotron, or table-top systems such as thermal globars as used in FTIR instruments, sources based on difference-frequency generation, or novel light sources, such as a laser-driven plasma source (Wagner et al., ACS Photonics 2018, 5, 4, 1467-1475). The spectral range of the broadband light source output might be tailored to only cover a small, narrowband region, e.g., using a bandpass filter, or a monochromator or spectrometer based on dispersion or diffraction. If the tip-sample region is illuminated with a broadband light source output, a wavelength-specific response may be extracted by placing the AFM tip at the output of an interferometer, e.g., a Michelson-type one. The setup is then identical to a standard Michelson-interferometer based FTIR spectrometer with broadband light input that is split by a beamsplitter where one part is then reflected off a fixed mirror and the second part is reflected off a movable mirror, before both reflections are recombined by the beamsplitter and focused onto the AFM probe. By sweeping the movable mirror the tip sees an interferogram of the light source output and records a mirror-position dependent sample response interferogram, from which a wavenumber or wavelength-dependent response can be calculated via a Fourier transform, analog to a standard FTIR spectrometer.

In another embodiment the sample is illuminated from the bottom instead of the top-down illumination of FIG. 2. Bottom illumination requires a transparent sample or sufficiently thin film (thickness within a few wavelengths) in the wavelength range of interest to allow transmission of light to the probed volume. Bottom illumination can have the benefit of less exposure of tip 203 and probe 201 to the laser pulses which can reduce artifacts that could occur when the probe itself absorbs light and gets heated. Another advantage is that bottom illumination may use a higher numerical aperture than top illumination since in top illumination the probe blocks part of the light while in bottom illumination the entire half space below the probe may be used for light focusing. Hence a smaller focus may result leading to a lower power requirement for the laser or less sample heating. The main benefit of bottom illumination is that it allows investigation of samples in a liquid environment, as described below.

For bottom illumination the sample may be placed or spin-coated, for instance, on a prism of a transparent material for the wavelength range of interest, e.g., ZnSe, ZnS, Si, diamond or Germanium. The laser beam may undergo total internal reflection in order for the beam to propagate inside the sample while being evanescent in the air. In this way, only the sample is exposed to the radiation leading to strong light-matter interaction. Alternatively, the laser beam may transmit without total internal reflection through a prism or a flat sample substrate. Such transmission geometry does not confine the light to the sample only, but also exposes the probe 201 to the light beam.

Such bottom-up configuration is most useful for measuring in liquid. The tip and sample region would then be surrounded by a fluid to study, for instance, biological specimens in their natural environment or electrochemical reactions. Since water absorption is minimized in the UV to near-infrared spectral region compared to the infrared region, water can be used as a liquid to study near-infrared absorption of biological matter in its native environment. Other suitable liquids, e.g., heavy water, with no or minimal absorption in the wavelength range of interest may be used to extend the wavelength range. Compared to top-down illumination with a longer distance for the light pass through the liquid, the water absorption would be minimized for bottom irradiation.

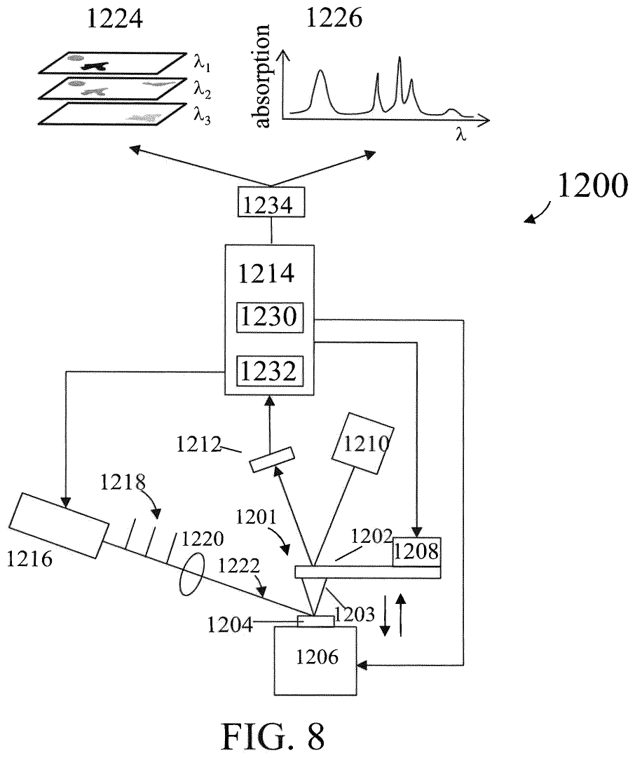

Turning to FIG. 8, the experimental setup 1200 is described for an embodiment of the nanoscale spectroscopy invention employing force volume mode. A probe 1201 with a cantilever 1202 that is terminated into a sharp tip 1203 is engaged on a sample of interest 1204. The IR probes 1201 are preferably coated with metal such as Au or PtIr in order to provide field enhancement from the lightning rod effect and light localization under the tip 1203. Sample 1204 is mounted on a stage 1206 of the atomic force microscope that includes a three-dimensional piezo scanner. A piezo 1208 may be coupled to the cantilever 1202. The sample stage 1206 and/or the piezo 1208, for example, provide a relative vertical motion between tip and sample while 1206 can also deliver in-plane XY motion for sample scanning. The vertical deflection of probe 1201 is detected using conventional beam-bounce optical detection with a diode laser 1210 and a position sensor 1212 (e.g., 4-quadrant photodetector). The vertical deflection is measured and routed to the controller 1214 for AFM feedback, e.g., controller 1214 controls the relative vertical position between tip 1203 and sample 1204 using at least one drive 1230 within controller 1214 (or separate) to control stage/xyz scanner 1206 and/or piezo 1208. As known in the art, the three-dimensional relative motion in xyz between tip 1203 and sample 1204 may be achieved by either moving the sample with xyz sample scanner 1206, or the tip with piezo actuator 1208 and additional xy-piezos, or by a combination of both tip and sample scanner piezos. The atomic force microscope controller 1214 may be equipped with Peak Force Tapping® mode capability, as described for instance in U.S. Pat. No. 10,845,382, and is notably and importantly capable of operating in Force Volume mode, as described for instance in U.S. Pat. Nos. 6,677,697 and 7,044,007 and 9,910,064, also assigned to Bruker Nano, Inc.

The controller 1214 also controls a frequency and wavelength tunable light source 1216 using optics controller 1232 of controller 1214. Optics controller 1232 may dictate the laser repetition rate and accept wavelength triggers in return from the light source, i.e. receive triggers corresponding to wavelength steps to correlate light-induced sample response data with wavelengths as required when acquiring wavelength-dependent spectra. It furthermore may set the light source wavelength, power, polarization, spectral width, pulse length, focus position or focus spot size, or other properties of the illumination. Light source 1216 may provide a wide range of wavelengths from the UV to the far-infrared. In an alternative, light source 1216 may be a broadband emitter, such as a laser-induced plasma, a globar, a synchrotron, etc. In one embodiment, source 1216 provides infrared radiation (IR) that matches the vibrational resonances of molecules in the material under test, i.e., sample 1204. Laser 1216, such as a quantum cascade laser (e.g., MIRcat, Daylight Photonics) or an optical parametric oscillator (OPO), delivers laser pulses 1218 at a frequency dictated by optics controller 1232. This laser repetition rate can be chosen by the user, or is automatically adjusted, for instance in a phase-locked loop (PLL) as part of controller 1214 in order to enable frequency tracking as described later. The light beam 1222 is focused onto the tip-sample region, i.e., the tip-sample interaction area, via a focusing element 1220, e.g., a 25 mm focus length off-axis parabolic mirror, or any other optical focusing element such as a lens.

The light-induced sample response is sensed via deflection changes of probe 1201 and is then associated with a sample position by controller 1214. This is repeated at different sample positions and/or for different light wavelengths, e.g. in form of a continuous wavelength sweep. The resulting spatial scans 1224 at different wavelengths (λ₁, λ₂, λ₃) and wavelength-dependent nanoscale localized spectra 1226 indicative of IR absorption are then processed and displayed on a screen of a workstation 1234 or saved as data by controller 1214 or a workstation 1234. Such IR imaging data can be obtained before, after or during acquisition of other sample property data, e.g., mechanical (modulus, adhesion), electrical (surface potential or currents in KPFM or TUNA) or other measurements that can be provided together with the AFM operational force volume mode.

Preferably, the relative position between the focus of the infrared beam 1222 and the tip 1203 is constant during IR data acquisition, i.e., the optical alignment to the tip is unchanged during IR absorption mapping across the sample and during point spectroscopy at a fixed sample location. This ensures that during an IR scan of the surface at a single IR wavelength the light intensity at the tip-sample interaction region where surface modification occurs is constant so that the surface response to the IR light can be quantitatively compared at different locations.

In a different embodiment the IR laser spot may be much larger than the AFM scan area so that light intensity variations while scanning the probe relative to the IR illuminated spot may stay sufficiently constant during scanning, e.g., within 10%. As a result, IR data at different positions of probe 1201 are only accurate to within 10% in this example since the laser power varies. In another embodiment the described effect of relative motion between probe and IR illumination area can be compensated. One way is to follow the probe position with the IR illumination spot during scanning. Another is to measure the spatial variation of the IR signal on a sample with a homogeneous IR response. Once the three-dimensional FV AFM-IR response is acquired for different xyz positions of probe 1201 with respect to the IR illumination spot while the probe is in contact with the sample, measurements on other samples can be corrected for the spatial IR light variation.

Controller 1214 or optics controller 1232 contains a frequency generator to pulse laser source 1216. A QCL for instance allows pulsing that follows an applied TTL signal. Alternatively, the IR pulses can be selected within the laser output beam 1222 via optical means under control of optics controller 1232, e.g., by an acousto-optical modulator, electro-optical modulator, or a Pockels cell. A mechanical pulse picker (chopper) or rotating mirror can also be used to allow only selected pulses to pass towards the tip while blocking unwanted pulses. It is understood that these elements may be inserted in the IR output of the IR light source, or they can be part of the IR light generation process within the laser system itself. In that case, for example, a Pockels cell may serve as a pulse selector to select the pump-laser pulses in an optical parametric oscillator or amplifier that drives the IR light generating process. What matters in the end is that tip 1203 is irradiated with laser pulses at a pulse repetition rate controlled by optics controller 1232. The IR light beam 1222 is linearly polarized along the tip 1203 resulting in field enhancement at the apex of the typically conductive or metal-coated (e.g., PtIr, Pt, or Au) tip 1203, a similar experimental condition as known for TERS or s-SNOM. Nonconductive tips and vertical light polarization with respect to tip 1203 result in reduced signal.

In force volume mode, the relative vertical position between probe 1202 and sample 1204 is altered using a drive signal from a drive 1230 within controller 1214 (or a separate drive under control of controller 1214). The drive signal causes sample scanner 1206 (specifically its z-scanner) to move, and/or piezo 1208. An equivalent drive to piezo 1208 is also possible, e.g., one that employs a magnetic, electrostatic, thermal or optical force onto the cantilever to cause a tip motion. Commonly used and important force volume parameters are a) the ramp rate or approach/retract velocities with which the tip-sample distance is changed during approach and retract segments, b) the trigger mode (e.g., absolute or relative), c) the hold or dwell time during which the tip interacts with the surface of the sample (also referred to as hold segment), d) the trigger type, e.g., z-position/height or force, on which to feed back during the dwell time, e) a trigger threshold, e.g., a certain force or height value that is used to trigger a change in tip-sample motion when it is met, f) the ramp size or desired maximum physical vertical displacement of the sample scanner 1206 or piezo 1208 during force volume, and g) other parameters such as feedback gains. As described later in more detail, in a typical force volume cycle the tip approaches the sample surface at a user-defined ramp rate or speed in an approach segment, stops the motion when a trigger force threshold is met, i.e., at a certain vertical deflection value, then controls, for that hold segment, the force (deflection) by continuous feedback over a defined hold time before the tip is lifted off from the sample in a retract motion in a retract segment.

Changes in the vertical deflection of the probe (or in the lateral/horizontal deflection) are typically analyzed in real-time with a lock-in amplifier. A lock-in amplifier is a physical device and/or an algorithm that demodulates the response of a system at a reference frequency. Lock-in amplifiers may be electronic assemblies that include analog electronics, digital electronics, and combinations of the two. They may also be computational algorithms implemented on digital electronic devices like microprocessors, field programmable gate arrays (FPGAs), digital signal processors (DSPs), and personal computers. A lock-in amplifier analyzes an oscillatory system and outputs different signals, including amplitude, phase, in phase (X) and quadrature (Y) components or any combination thereof. The lock-in amplifier in this context can also produce such measurements at both the reference frequency and higher harmonics of the reference frequency.

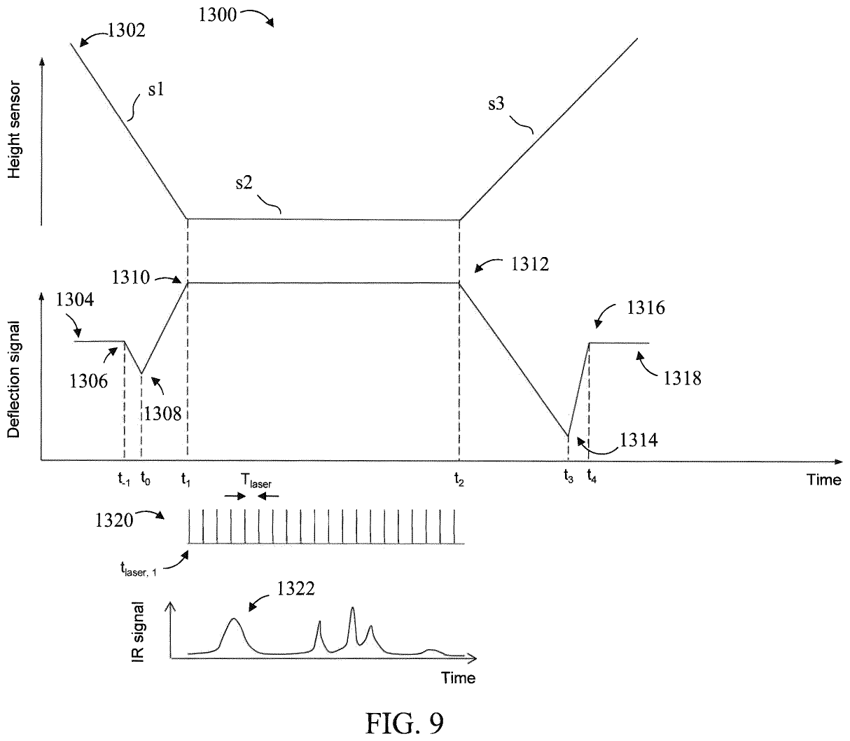

In FIG. 9, a preferred embodiment 1300 of FV AFM-IR is displayed with a single approach segment, hold segment and retract segment. Curve 1302 depicts the AFM height sensor signal for a single FV AFM-IR cycle, i.e., the physical vertical displacement of the sample scanner 1206 or piezo 1208 as measured by a sensor. The corresponding probe deflection is shown with signal 1304, representing a force curve, i.e. force (deflection) as function of time (with the given height sensor information it can be converted to a force-distance curve, or force-separation curve after taking indentation into account). During the approach segment s1 the probe-sample distance is linearly reduced at a user-adjustable ramp rate or approach velocity (slope of the segment) by either moving the probe or the sample or both towards each other. At time t₋₁ the probe deflection changes at point 1306 since the probe starts to feel the attractive van der Waals forces of the nearby sample surface and starts bending towards the sample in this example. It snaps into contact (negative deflection) with the sample at time t₀ and point 1308. After that, sample scanner 1206 or piezo 1208 continue the approach in segment s1 so that the deflection signal now increases, i.e., the probe bends upwards. When the desired force, i.e., deflection, setpoint is reached the feedback stops the relative probe-sample motion in point 1310. Other parameters could also be used to trigger a stop in approach motion, e.g., a certain tip-sample current, but most commonly a force, defined height or height sensor value is employed.

Once the approach segment has finished and the desired setpoint 1310 has been reached, a hold segment s2 follows. There are different options for feedback during this segment: the deflection signal can continuously be held at a force setpoint, i.e., constant deflection, or at a constant height or height sensor value. In the first case, any drift in the vertical distance between tip and sample, e.g. from thermal changes, can be corrected, i.e. a constant force is kept. When using a constant height or height sensor instead, such drift would not be measured and corrected, leading to a changing tip-sample interaction force in case a drift in the relative tip-sample position occurred. Note that any drift of the deflection measurement system involving the probe, the deflection laser and the deflection detector cannot be corrected during the hold segment since such change is indistinguishable from a change in tip-sample interaction force.

However, in each force volume cycle the baseline deflection is subtracted for a relative trigger, i.e., the deflection difference between setpoint 1310 and before point 1306 where the tip does not yet feel the sample represents the desired trigger force. The hold segment is executed for the user-adjustable hold time. Once the hold time has elapsed at time t₂ the tip-sample distance is increased during the usually linear retract segment s3, in the simplest case at the same ramp rate or speed as for the approach segment s1. Consequently, the deflection decreases starting at point 1312. The deflection and hence the force can only decrease to point 1314, the adhesion point. At this point the adhesion force between tip and sample is as large as the mechanical force of the cantilever from bending. Beyond time t₃ the force necessary to bend the probe exceeds the adhesion force: the tip no longer sticks to the sample surface and the probe snaps off from the surface. At a time t₄ in point 1316 the probe has relaxed back to its equilibrium position so that the deflection in 1316 is the same as before point 1306 (when any drift is absent). The retract segment s3 ends at the maximum vertical displacement of sample scanner 1206 or actuator 1208 (FIG. 8) which is the ramp size. A potential next FV-cycle starts again with segment s1, e.g. after changing the xy sample position in FV AFM-IR imaging.

Approach and retract segments usually follow a pre-defined, linear deflection profile, or a pre-defined, linear Z motion. A nonlinear profile is also possible. Typically, the lateral tip motion to a new xy sample location occurs when the tip is fully detached from the surface, e.g., at the largest tip-sample distance in the turnaround point between retract and approach motion. Since this positioning to a new xy spatial coordinate takes place without any tip-sample interaction when the probe is not engaged with the surface, the lateral forces on the tip vanish. This is in contrast to contact mode where the tip is dragged across the surface to new xy positions, causing lateral forces on the tip and leading to tip wear and tip contamination. Note that the ramp rate and ramp size during the approach and retract segment, and the hold time during the hold segment determine the time it takes to complete one single FV AFM-IR cycle for a simple force curve profile of approach, hold and retract.

Apart from the time it takes to complete a cycle, these parameters may also influence the tip-sample interaction force. A faster ramp rate usually implies a larger force overshoot at the time the trigger threshold is met due to the system's inertia and the limited speed of the feedback system. A larger ramp size at constant ramp rate also increases the approach/retract speed and the force overshoot. If the ramp size is too small on the other hand, the tip might stick to the surface due to adhesion forces and is not able to lift off from the surface in the retract segment, so that the tip stays in contact with the sample when moving between spatial xy pixels for consecutive FV AFM-IR cycles. In general, it is desired to minimize the FV AFM-IR cycle time in IR imaging (to allow faster data acquisition) while still maintaining good force control, little force overshoot, complete lift-off from the surface and no lateral forces. Note that force overshoot can be avoided by a slower, nonlinear approach with the ramp rate slowing down when getting closer to the force setpoint. Preferably during the hold segment, but possibly also during approach and retract segments the IR light source delivers pulses to the tip-sample region, causing a light-induced deflection change that can be used to infer sample absorption. The same force curve may also deliver more than nano-chemical absorption data, e.g., nano-mechanical information such as the modulus from the approach or retract segments, or the adhesion from the most negative deflection before the tip snaps off from the surface.

Oftentimes it is desired to modify the parameters of the force measurement in a non-cyclical manner, including the speed at which the tip-sample separation is modulated, the duration of a pause (hold time, to allow molecular binding between the tip and molecules on the surface, for example), etc. to analyze forces corresponding to, for example, complex mechanical models of certain samples. In U.S. Pat. Nos. 6,677,697 and 7,044,007 assigned to Bruker Nano, Inc., each of which is expressly incorporated by reference herein, a system and method are disclosed in which the flexibility in performing the force measurement is improved. For instance, a specific change or rate of change in the tip-sample interaction force can be applied, or a sequence of such measurement conditions can be applied to cause a desired force profile.

It is also important to point out key aspects of the trigger threshold in force volume mode. In contrast to contact mode, force volume mode can also use a relative trigger threshold, not just an absolute one. An absolute trigger threshold means that the force setpoint is absolute and any system drift in the deflection signal is not corrected. That results in a poorly controlled tip-sample interaction force since a constant deflection value is kept for the probe on the sample surface, while the probe deflection away from the sample surface, which is unaffected by sample forces, may drift due to environmental changes, for instance.

The option of a relative trigger threshold in force volume mode means that the force setpoint is measured relative to the deflection baseline of the unperturbed probe away from the sample surface. Hence, tip-sample interaction forces in the force curve of force volume are much better controlled due to this deflection offset or baseline subtraction, leading to higher precision and repeatability in the applied tip-sample interaction forces for each force volume cycle. In contrast, contact mode usually uses an absolute trigger threshold and does not subtract a deflection baseline of the unperturbed probe. Even if baseline subtraction was implemented, in contact mode the tip stays on the sample surface over an extended period of time of several minutes to tens of minutes, much longer than a typical pixel time for a single force curve in force volume mode, which is about a few milliseconds to seconds or a few minutes. In a recent improvement, see U.S. Pat. No. 9,910,064 assigned to Bruker Nano, Inc., and expressly incorporated by reference herein, the force-control in force volume also takes into account any baseline deflection changes, background contributions and artifacts during the ramp process to further separate the desired tip-sample forces from false force artifacts. Specifically, this enables approach and engage with the surface in force volume using a negative force setpoint.

During the hold segment s2 in FIG. 9 of, for instance, constant deflection or constant height, AFM-IR data can be collected. Curve 1320 depicts light source pulses, e.g. from an infrared laser source, that are synchronized to start at time t_{laser,1} before or after a certain time delay with respect to the start of the hold segment at time t₁. Here the laser pulses have a constant repetition rate, i.e. the pulses are equally spaced in time by a period Tₗₐₛₑᵣ. In one embodiment the AFM-IR detection method is based on resonance enhanced AFM-IR (resonance enhanced contact mode IR). In that case of resonance enhanced FV AFM-IR the laser repetition rate is preferably set to substantially match the local contact resonance of the probe (or a fraction of it, i.e. ½, ⅓, ¼, 1/n with integer n) to maximize the laser induced oscillation amplitude of the probe as measured in the deflection signal and extracted by a lock-in amplifier, typically as an amplitude signal. If the wavelength of the laser stays constant, the lock-in amplifier delivers a constant amplitude signal during the hold segment s2 that is proportional to the IR absorption at the probed sample position. The signal may be integrated or averaged during the hold segment to increase the signal-to-noise ratio. The force volume curve 1304 may then be repeated at a different xy sample position to create a map of IR absorption. Note that the movement between xy positions in force volume occurs after the tip has left the sample, namely at the end of the retract segment s3 and before a new approach segment s1 is started in the next force volume cycle. In general, such an xy movement occurs later than time t₃ when the tip is no longer in contact with the sample surface. This way, the lateral forces on the tip are fully avoided that occur in contact mode, or also in tapping and peak force tapping to a much smaller extent.

The hold segment may also be used to obtain a wavelength-dependent absorption spectrum at the probed sample location. This is depicted in curve 1322 where the IR signal is extracted from the deflection signal while the light source wavelength is swept during the force volume hold segment. In one embodiment the wavelength sweep is repeated within the same hold segment and the obtained IR spectra are averaged to increase the signal-to-noise ratio. In another experiment the probe is retracted from the surface after a single IR spectrum has been acquired, but then the process is repeated in consecutive force volume cycles at the same sample location, before averaging all spectra from all cycles.

In another embodiment of FV AFM-IR the hold segment s2 has a vanishing length, i.e., it is absent. In this case the relative tip-sample approach during approach segment s1 is stopped and reversed as soon as the trigger threshold, e.g., a trigger force, has been reached. The light source may now illuminate the tip-sample region during the approach segment, retract segment or both and an IR absorption signal is extracted. The force would then vary during which IR signal is acquired.

In another embodiment, surface sensitive FV AFM-IR, the light induced sample response is obtained using the surface sensitive AFM-IR method during the force volume cycle. The tip is mechanically oscillated on the surface in contact with the sample via modulation of the vertical sample position with scanner 1206 or via modulation of the tip position with piezo 1208 (FIG. 8). This oscillation typically occurs in resonance with a cantilever mode, e.g. at 1750 kHz. Off-resonant drive is also an option. IR detection occurs at a different mode with a preferably large frequency separation from the mechanically excited one, e.g. at 50 kHz, and the laser is pulsing at the difference-frequency of both modes (here 1750-50 kHz=1700 kHz). Overall, the frequency-mixing detection scheme where the signal of interest is read out at the difference-frequency between mechanically driven probe resonance and laser repetition rate is the same as in tapping AFM-IR, however, now the tip is kept in contact with the surface compared to the intermittent contact of tapping AFM mode. Surface sensitive FV AFM-IR has the benefit over resonance enhanced FV AFM-IR of a reduced probing depth with therefore higher surface layer sensitivity and better lateral resolution.

Note that the light-induced probe deflection changes in a preferred embodiment of the invention is originating from a photothermal expansion, i.e. light absorption, local sample heating and local sample expansion leading to a surface pulse force detected by the AFM probe. In other embodiments, the light induced surface pulse force may for instance originate from a local sample compression after light absorption, or from softening or hardening of the sample with changes in modulus, stiffness or adhesion. In addition to these mechanical property changes, the surface pulse force may be caused by electromagnetic forces, e.g., from light induced dipole forces, charge accumulation, charge displacement, charge oscillation such as in plasmons, or sample polarization. While light absorption with photothermal expansion is most common in the infrared spectral region, other wavelength ranges from the ultraviolet (UV) to the far-infrared (e.g. terahertz) may exhibit different physical phenomena such as plasmon excitation in the visible or near-infrared that may all cause detectable changes in the AFM probe deflection.

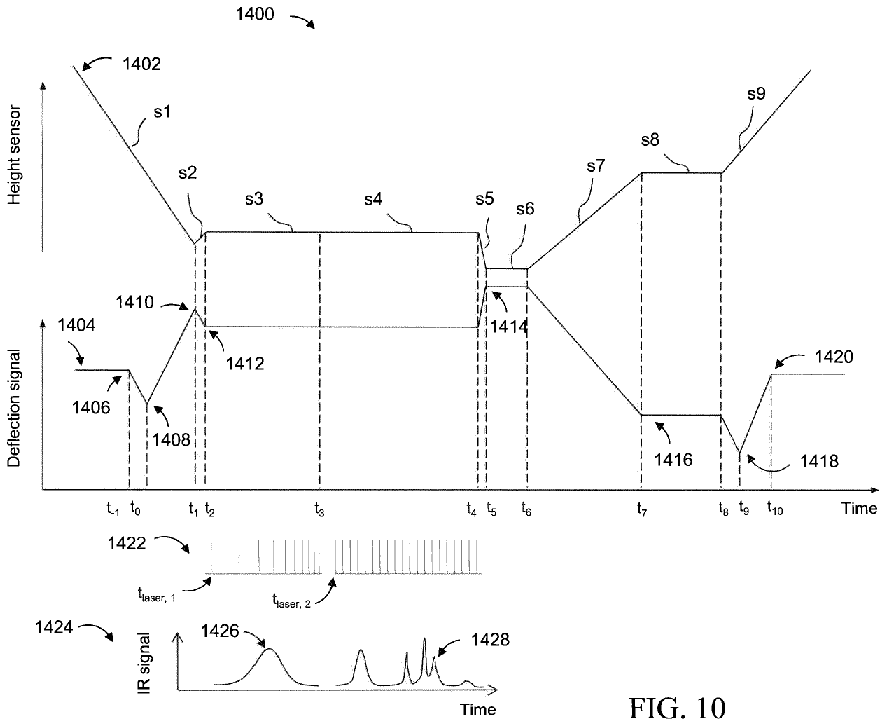

FIG. 10 illustrates another embodiment 1400 of the invention, highlighting the use of multiple segments, i.e., using a more general FV AFM-IR cycle employing multiple approach, retract and hold segments to perform IR spectroscopy experiments, but also, if desired, allowing the combination with non-IR experiments, e.g., nanomechanical or nanoelectrical ones. The height sensor signal 1402 is shown together with the deflection signal 1404. As in the implementation 1300, a linear approach segment s1 reduces the tip-sample distance. The probe bends towards the sample at point 1406 and snaps into contact with the sample at point 1408. The deflection increases afterwards until a trigger threshold has been reached at point 1410, causing the tip-sample motion to change direction in this example at time t₁ until another trigger threshold is reached at time t₂ and point 1412.

Note that segment s2 here is intentionally a retract segment, different from an artifact such as a force overshoot during approach. In the latter case the approach speed (ramp rate) during approach segment s1 may be too large so that the tip-sample motion cannot stop immediately when the trigger threshold 1410 is reached, or the feedback does not react fast enough. The deflection and hence force increases further, and the feedback adds a retract segment s2 to ensure meeting the desired setpoint force at point 1412. Whether intentionally or correcting a force overshoot, a hold segment s3 follows during which the feedback keeps the deflection constant at a predefined force or height value. After a defined hold time t₃−t₂, another hold segment s4 follows at time t₃ in this multi-segment embodiment, here at the same force or deflection as employed in segment s3. Between times t₄ and t₅ the force is increased in segment s5 with a faster ramp rate (larger slope) than in s1. Hold segment s6 has then a hold time of t₆−t₅ at the higher force 1414 before in retract segment s7 the force is slowly reduced, now at a different slower ramp rate.

At time t₇ the new setpoint 1416 is reached. Note that the deflection signal is lower now than at the equilibrium position of the probe before time t₋₁ at point 1406. That means that the tip sticks to the surface and is bending downwards, indicating a negative force between tip and sample, a pulling force on the surface from adhesion between tip and sample. This regime of a negative tip-sample interaction force is maintained during hold segment s8 before, in the last retract segment s9 starting at time to the tip is retracted from the sample surface at another adjustable ramp rate. During that retract period the tip snaps off from the surface at point 1418 at time t₉. At this point the pulling force has overcome the adhesion force and the tip leaves the surface. This adhesion point 1418 defines the maximum adhesion force between tip and sample and is a nanomechanical property that can be readily obtained from the FV AFM-IR deflection curve 1404. Other properties such as the modulus can also be deduced from the deflection curve, e.g., during segment s7, the retract curve, while still in contact with the sample.

After the adhesion point 1418 the probe relaxes to its previous equilibrium position so that the deflection after point 1420 is identical to the deflection signal before point 1406. Note that the deflection in general also oscillates around the equilibrium position beyond point 1420 for some time after the tip has snapped off from the surface (at the probe's free resonance, not shown in 1404).

In 1422 the combination with laser illumination for IR spectroscopy or imaging is shown, now for the situation of two hold segments in contrast to FIG. 9. IR laser pulses are overlapping in time with segments s3 and s4 of the force volume cycle. In this example the AFM-IR detection method is resonance enhanced AFM-IR. The probe's contact resonance frequency is found from the infrared sample response in hold segment s3 and then this frequency is used to set the laser repetition rate to subsequently acquire a wavelength-dependent IR spectrum in segment s4. Here, once the desired force setpoint has been reached in point 1412, laser emission is started at time t_{laser,1} at a defined delay chosen at or after time t₂ (before t₂ is less preferred since the force is not constant yet). The repetition rate is swept within a defined range from a start to stop frequency within hold segment s3, and the IR signal is extracted from the laser induced deflection change. Such deflection change is displayed in 1424 where the IR signal is for instance obtained from the amplitude output signal of a Lock-In amplifier that demodulates the deflection signal at the laser repetition rate. If the sample is absorbing at the chosen wavelength, and the contact resonance lies within the chosen frequency sweep range of the repetition rate, the IR signal 1426 depicts at least one maximum at a certain time, corresponding to a certain laser repetition rate at that time. This contact resonance frequency of the probe is then chosen in hold segment s4 as the optimum laser repetition rate for a wavelength sweep that is started at time t_{laser,2}. The obtained time-dependent IR signal that is proportional to the sample absorption is then obtained in 1428. Since every position in time corresponds to a well-defined wavelength step during the wavelength sweep (e.g., associated with wavelength trigger signals emitted by the light source for well-defined wavelength steps), a wavelength-dependent absorption spectrum of the sample is acquired. Note that the purpose of finding the contact resonance in s3 was to optimize the IR signal in resonance enhanced AFM-IR mode. A different sample location in general has a different stiffness or modulus so that the local contact resonance frequency varies and needs to be determined ideally for each local position on the sample in order to maximize the IR signal in resonance enhanced mode.

Note that in the discussed example there are several hold segments of constant force or height and several approach and retract segments. Each of those approach, hold and retract segments can be used for IR or non-IR data acquisition, or a combination. In above example segment s3 was used for a sweep of the IR laser repetition rate to find the local contact resonance from the IR absorption data, while the result was used in a subsequent wavelength sweep for an IR absorption spectrum measurement in segment s4.

In another embodiment the FV AFM-IR multi-segment cycle can be used to acquire IR spectra or single-wavelength data for different tip-sample interaction forces within one FV AFM-IR cycle at one spatial sample location. Instead of finding the contact resonance frequency via optical means in 1426, the tip could also be excited mechanically into an oscillation using piezo actuator 1208 or similar means, e.g., a thermal tune (U.S. Pat. No. 8,680,467). A frequency sweep of piezo actuation while recording the oscillation amplitude would lead to a similar contact resonance curve 1426. In another embodiment the contact resonance would not need to be found at all. Either a constant laser repetition rate is chosen and local variations in stiffness and hence contact resonance frequencies would not be corrected for, or a phase-locked loop (PLL) or similar would automatically follow any such contact resonance shift.

In another embodiment the segments can also be used to execute electrical measurements, e.g., in Kelvin-probe force microscopy or conductive AFM. The tip may need to stay in contact with the sample, or can be lifted a certain distance (e.g., in KPFM). Any external stimulus on the tip-sample interaction region can be applied in any segment, either in an approach, retract, hold segment or even when the tip has left the sample surface. One may apply a magnetic field during a segment while the following segment acquires an IR spectrum or single-wavelength data point with the magnetic field still present, or already turned off. In a subsequent segment the field could be reversed, followed by another segment used for IR acquisition. Other IR modes can also be applied within or between segments. While the resonance enhanced AFM-IR method is the preferred technique applied during the hold segment, a switch to tapping AFM-IR in another segment (hold, approach or retract) works as well. Or an additional tip-sample interaction force modulation via a sample or tip modulation enables the use of the surface sensitive AFM-IR mode (U.S. Pat. Nos. 11,237,105, and 11,215,637, or Mathurin et al., Journal of Applied Physics, 2022, 131, 010901). Single IR pulse excitation is possible too as in the first NanoIR implementation (U.S. Pat. No. 8,402,819) using a single IR pulse per segment with, e.g., subsequent data extraction via an FFT of the laser-induced deflection change.

As shown in curve 1404 the applied force in FV AFM-IR can also be negative, i.e. a pulling force between tip and sample. This can be achieved in contact mode IR as well; however, it is more unstable. In FV AFM-IR, each FV cycle determines the force relative to the undisturbed deflection of the probe when the probe is not in contact with the sample. That means for each spatial pixel on the sample the deflection signal before time t₋₁ or point 1406 is used to determine the deflection signal background. In this way any drift of the deflection signal is measured and corrected for. Such drift in the deflection signal of the probe when not in contact with the sample can originate for several reasons: the cantilever of the probe might bend over time depending on changes in the environmental conditions such as temperature or humidity changes, the deflection laser position may move on the cantilever, the deflection laser power might drift leading to a change in probe heating, or other external forces slowly varying with time (e.g. electrostatic ones) might affect the cantilever bending. FV does correct for these drifts, i.e. positive or negative applied forces on the sample are well-defined over the relatively short FV cycle times of typically milliseconds to tens of seconds up to a few minutes.

On the other hand, in contact mode IR, resonance enhanced or non-resonant, such drift is not corrected for and the setpoint is always absolute. Consequently, imaging over typically several minutes to tens of minutes means that the force is not well controlled between the spatial pixels. In FV the force in each pixel is controlled based on aforementioned background or baseline subtraction from repeatedly retracting the tip from the surface. In contact mode, the tip is not retracted between pixels of an image. Hence, FV AFM-IR has this unique benefit of a well-defined force in contrast to (resonance enhanced or non-resonant) contact mode IR. This can be useful especially at negative forces and a small deflection difference to the adhesion point, where any drift could cause the tip to snap off the sample surface. Such negative forces may be employed in studying single molecules. The mechanical properties of single molecules have been determined in AFM in pulling experiments (e.g., Hughes et al, Rep. Prog. Phys. 79, 076601 (2016)), but no related IR spectroscopy data exists due to the lack of a suitable technique, a gap FV AFM-IR closes.

FV AFM-IR enables the researcher to first image the molecule on a surface without the lateral forces of contact mode that would prevent such imaging, and then the molecule can be pulled up with a negative force setpoint in FV after engage. IR data can then be acquired either at constant positive or negative force setpoint, or during a well-defined change in the push and pull forces during approach and retract motion, respectively, of the tip on the molecule. Such capability for fine force control and the acquisition of force curves is a unique benefit of FV AFM-IR over contact mode IR or tapping mode IR.

Note that in general there are more than one contact resonances so that multiple resonance peaks such as 1426, e.g., 306 and 312 in FIG. 3, would be observable depending on the chosen frequency range in both a mechanically driven sweep (using, for example, a piezo actuator to induce a probe oscillation), or an optical one (where the infrared laser is swept in repetition rate). The availability of multiple probe resonances is valuable in itself, especially in an IR absorption measurement, i.e., when originating from an optical photothermal excitation as displayed in 1426. In one embodiment of the FV AFM-IR multi-segment experiment, an IR-induced frequency sweep spectrum as in 1426 can be obtained over a large laser repetition rate range on each pixel of a sample, for a single laser wavelength or a full IR absorption spectrum over several wavelengths. IR absorption images can then be calculated from that data set for each laser repetition rate, i.e. one could obtain an IR absorption image at the absorption wavelength of one component of the sample for multiple contact resonance frequencies of the probe. It is known (U.S. Pat. No. 11,237,105) that an increased IR pulse repetition rate leads to a smaller thermal diffusion length and hence to a higher spatial resolution that also limits the sensitivity to closer to the top layer of the sample. In contrast, a lower repetition rate is associated with a larger diffusion length (larger probing depth) and hence a lower spatial resolution. The photothermal signal is then less confined to the surface and originates more from regions deeper under the sample surface. As a consequence, obtaining IR images or spectra for different laser repetition rates allows to adjust the probing depth and obtain depth information of the sample, i.e., provides a way to study the vertical composition of the sample and distinguish and identify deeper layers from layers closer to the top surface. This also applies for the surface sensitive IR mode (U.S. Pat. Nos. 11,237,105 and 11,215,637) that is fully compatible with FV.

In another embodiment, a sequence of consecutive hold segments with the same force can be used to obtain a sample absorption spectrum not at a constant laser repetition rate, but from a repetition rate sweep at each wavelength. For instance, for a first laser wavelength a first hold segment s3 would lead to an IR signal resonance 1426 at the probe's contact resonance. In a subsequent hold segment s4 the same laser repetition rate sweep would be executed but now for the next wavelength step. Repeating these steps leads to a wavelength-dependent sequence of resonance curves 1426. From the resonance curve the IR signal can be extracted either by integration over the curve, or fitting the curve, e.g., with a Lorentzian line shape and using the fitted amplitude. An IR absorption spectrum may be plotted this way. A benefit of such an approach is that any change of the contact resonance, either from sample position, or softening or melting of the probed sample due to IR absorption, does not need to be compensated with a PLL or frequency-tracking, but is intrinsically contained in the measured resonance curve 1426 whose center frequency may shift but is still contained within the repetition rate sweep window.

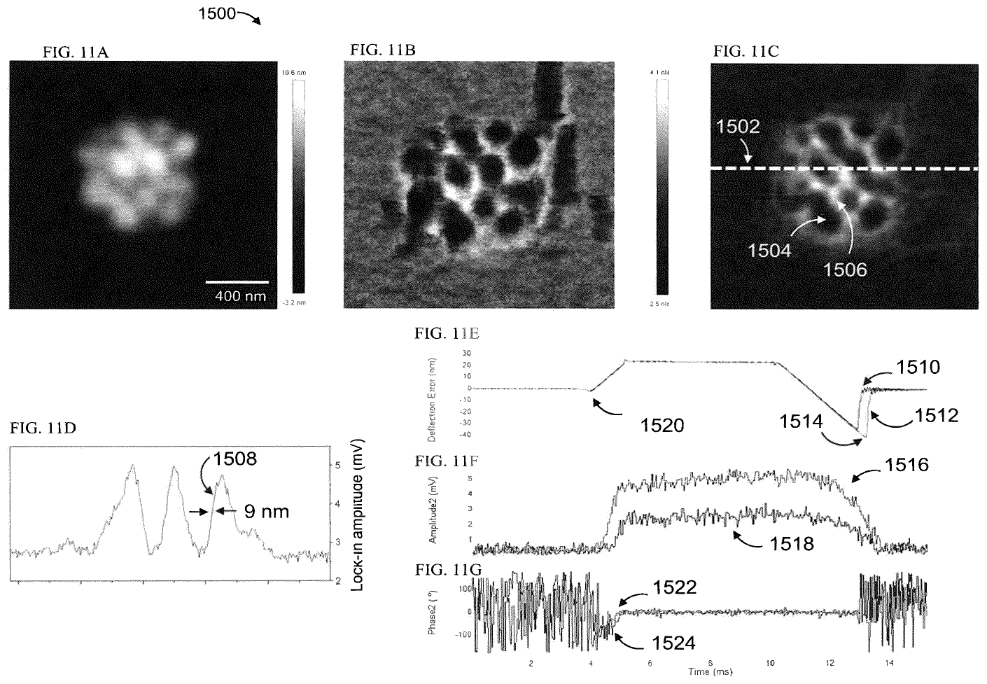

We now turn to experimental data, first to resonance enhanced FV AFM-IR imaging using a PLL for frequency-tracking. FIG. 11 shows FV AFM-IR imaging data 1500 (topography, adhesion, IR absorption). In FIG. 11A the topography is shown for a diluted PS-b-PMMA block-copolymer sample. A gold-coated, 450 μm long probe with a spring constant of 0.1 N/m is used. A ramp rate of 98 Hz and a ramp size of 140 nm is used to acquire this 256×256 pixel image within 20 min. Note that typical ramp rates are smaller than 300 Hz and typical ramp sizes are 30-300 nm, depending on the sample material and roughness. The height sensor image in FIG. 11A reveals the sample's topography and shows the assembly of multiple smaller nanoparticle-like objects. The corresponding adhesion data is concurrently obtained and shown in FIG. 11B revealing an adhesion contrast between the nanoparticle core and the surrounding shell. The IR absorption is displayed in FIG. 11C at the 1730 cm⁻¹ carbonyl-absorption of the PMMA component in the block-copolymer. The dark domain areas inside the assembly are consequently not PMMA but PS. The laser is tuned to a higher-order contact resonance of the probe at around 1745 kHz and a phase-locked-loop is active to compensate for any contact resonance frequency shift during scanning. The resonance enhanced IR data was obtained during the 5 ms long hold segment of the FV curve (FIG. 11E).

The spatial resolution achievable is at least sub-100 nm, and most often sub-50 nm, and even sub-10 nm. To wit, the spatial distribution of the IR active material indicates an accumulation of PMMA in the shell of the nanoparticles, so the nanoparticles seem to contain a PS core covered by a PMMA shell. The line cut in FIG. 11D at the position 502 highlighted in FIG. 5C confirms a spatial resolution in the IR response of 9 nm, defined as the 80%-20% points of the rising edge 1508. In FIG. 11E two force curves are displayed, curve 1510 was taken at spot 1504 in FIG. 11C, i.e., on PS, while force curve 1512 was taken on one of the bright domain walls at spot 1506. The force curve is given as a deflection error over time, i.e., the deflection signal minus its baseline value before approx. 4 ms where the tip does not yet interact with the sample (discussed earlier). The force during the 5 ms hold segment can be calculated from the approximately 25 nm maximum deflection error as 25 nm times 0.1 N/m (spring constant), resulting in 2.5 nN. As explained before, the tip lifts off the surface at point 1514, and this point marks the adhesion force between tip and sample at spot 1506 (a similar point occurs at spot 1504, albeit slightly earlier). This adhesion point is measured in FIG. 11B with each FV curve. The PS FV curve 1510 shows a smaller adhesion force relative to the deflection baseline in FIG. 11E consistent with FIG. 11B. The corresponding IR amplitude signal from a Lock-In amplifier output for continuous laser pulsing during the FV AFM-IR cycle is shown in FIG. 11F. Notably, although the laser pulses illuminate the tip-sample interaction region during the approach, hold and retract segments of the force curve, the IR signal is not present when the tip has not contacted the sample yet, i.e., for times earlier than 4 ms.

The IR signal rises starting when the tip snaps into contact with the sample at point 1520 until it reaches a maximum at the start of the hold segment. During the hold time the IR signal stays approximately constant, with a higher value for curve 1516 which corresponds to the PMMA domain wall in spot 1506. When the tip lifts off the surface at point 1514, some IR amplitude still persists for a fraction of a millisecond. The corresponding phase output of the Lock-In amplifier is given in FIG. 11G. Since a phase-locked-loop was employed to maximize the IR signal by following the local shifts in contact resonance frequency, the IR phase is kept at zero by the PLL for non-zero IR signals, which occur during the hold segment. Outside the hold segment where no IR signal is present, the IR phase is random, the PLL cannot lock to any signal. During the hold segment the phase noise is lower in curve 1522 that corresponds to the higher IR amplitude curve 1516. Note that between times 4 ms and 5 ms the PLL is still adjusting the frequency resulting in a non-zero IR phase that converges to zero within that 1 ms time window. One could also turn on the PLL only during the hold segment or at an earlier defined time relative for instance to the snap-in contact point 1520, or to a point at which the deflection starts to change during the approach segment. Note also, that the laser here was continuously pulsing during all FV AFM-IR cycles, during the approach, hold and retract segments. In order to limit sample heating it is also possible to time the laser emission such that it only occurs during the hold segment.

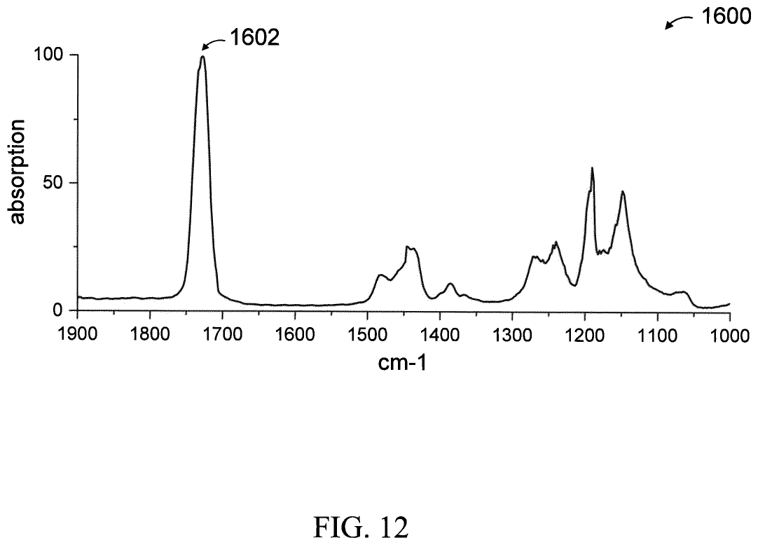

FIG. 12 shows a nanoIR point spectrum 1600 of sample absorption obtained using FV AFM-IR on a PMMA sample. A soft probe with a spring constant of 0.4 N/m was used at a constant hold force of 0.5 nN during the hold segment. The probe contact resonance was 1365 kHz and the phase locked loop was turned off, i.e., frequency tracking was disabled so that the spectrum was taken at a fixed contact resonance (1365 kHz in this case). This is justified since in contrast to scanning over different materials, the contact resonance is not expected to change at a fixed sample position (unless sample softening or melting for excessive laser power occurs). A hold time of about 120 seconds was used to consecutively acquire ten spectra at ten (10) seconds each during a single hold segment. Then, all 10 spectra were averaged.

In the resulting point spectrum 1600 an absorption peak 1602 occurs at 1730 cm⁻¹ corresponding to the PMMA carbonyl band. Spectrum 1600 also shows significant sample absorption response at about 1450 cm⁻¹ and 1200 cm⁻¹, which represent other absorption lines that uniquely identify PMMA. Overall, the nanoIR spectrum obtained in FV AFM-IR matches the PMMA spectrum as acquired in standard far-field FTIR spectroscopy (not shown), so that the FV AFM-IR spectra can be used for nanoscale material identification in the same way as in resonance enhanced AFM-IR, tapping AFM-IR or Peak Force IR.

In the above example, ten (10) 10 second-long spectra were acquired during a single hold segment. In another embodiment the hold time can be set to match or slightly exceed the acquisition time of a single spectrum (here 10 sec) and after each spectrum acquisition, the tip is retracted in the FV AFM-IR cycle in a retract segment that is followed by the approach segment of the next FV AFM-IR cycle after which the next spectrum is recorded in the hold segment. In this way, one spectrum is measured per FV AFM-IR cycle with the benefit of precise tip-sample interaction force adjustment in each cycle, as compared to acquiring all spectra for averaging in a single FV AFM-IR cycle with a much longer hold segment, during which the tip-sample interaction force might drift and change. Note that the spectrum acquisition time is determined by the desired signal-to-noise ratio, the desired wavelength range, the data acquisition speed and the laser capabilities. For modern quantum cascade lasers (QCLs) a single spectrum covering the IR fingerprint region of ˜800-1800 cm⁻¹ can be obtained within 30-100 ms, or even less for a reduced wavelength range. Hence, the FV AFM-IR hold segment to acquire a single NanoIR spectrum might be as short as 30-100 ms for a full ˜800-1800 cm⁻¹ spectrum. This is especially interesting for hyperspectral imaging where a spectrum is recorded in each pixel of an xy sample scan. Other laser systems such as optical parametric oscillators (OPOs) usually require much more time to sweep the wavelength, in the range of several seconds to 10 s of seconds for a 1000 cm⁻¹ wide spectral window.

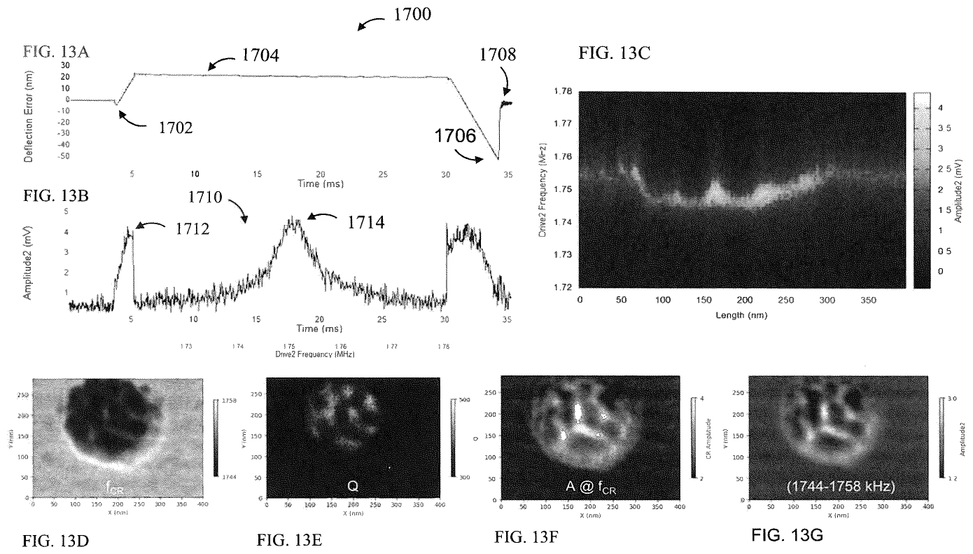

FIGS. 13A-13G illustrate a preferred embodiment of FV AFM-IR used to image a diluted PS-b-PMMA block-copolymer sample, the same as in FIG. 11 but at a different sample position and using an IR laser repetition rate sweep in each pixel. A gold coated, 450 μm long cantilever with a spring constant of 0.1 N/m is employed. A ramp rate of 98 Hz and a ramp size of 120 nm is used to acquire this 256×256 pixel image within 38 min. The IR response is measured at a wavelength of 1730 cm⁻¹. A force curve 1700 at a single pixel is illustrated in FIG. 13A. A snap to contact point 1702 is followed by a 25 ms long hold segment 1704 at a force of 2 nN, followed by a retract segment until the probe tip releases from the surface at point 1706 and settles at the equilibrium deflection at 1708. FIG. 13B shows the IR amplitude response 1710 while the laser repetition rate is swept between 1720 and 1780 kHz during the hold segment.

Outside of the hold segment the laser repetition rate is kept at 1750 kHz which is close to the local contact resonance. This is the reason why the IR amplitude increases after the snap-in-contact point 1702 until before point 1712, i.e., a maximum is reached at which the local contact resonance coincides with the constant laser repetition rate. At the start of the hold segment in point 1712 the laser repetition rate switches to the start value 1720 kHz of the repetition rate sweep. At this start frequency there is no overlap yet with the contact resonance and hence the IR amplitude drops close to zero after point 1712 at around 5-6 ms. The laser repetition rate is then increased linearly during the sweep and the IR amplitude peaks in point 1714 at the overlap of laser repetition rate and contact resonance, before the IR amplitude drops again when the mismatch between these frequencies increases. At 30 ms the hold segment stops and the laser repetition rate here is restored to its previous value of 1750 kHz, now matching again the contact resonance so that the IR amplitude jumps up. During the retract segment the change in tip-sample force leads to a shift in contact resonance frequency, leading to a decrease in IR amplitude until the probe tip lifts off from the sample surface at point 1706.

FIG. 13C is an image of the IR amplitude for the position dependent laser repetition rate sweep, i.e., a 400 nm long line scan was performed across an assembly of diluted PS-b-PMMA nanoparticles and for each point a laser repetition rate sweep in FV AFM-IR as in FIG. 13B was conducted. Between zero and approximately 70 nm and 300 and 400 nm, the tip is on the substrate and the contact resonance (i.e., the laser repetition rate, or Drive 2 frequency here, with the strongest IR amplitude response) is at around 1.755 MHz. On the nanoparticles in the 70-300 nm range, the contact resonance is up to 100 kHz lower and varies depending on whether a nanoparticle or its shell is probed. An image of changes in the local contact resonance frequency (f_{CR}) is shown in FIG. 13D, with f_{CR} obtained as the center frequency of Lorentzian line fits to the resonance curves (such as in FIG. 13B). As discussed with respect to FIG. 13C, the substrate outside the nanoparticle assembly reveals a higher contact resonance than the assembly itself. And within the assembly the larger domains of the PS core areas have the lowest contact resonance while the PMMA shell around the PS domains exhibit a higher resonance. FIG. 13E displays an image of the local Q factor for the contact resonance as extracted from the Lorentzian fits. The PS domains reveal a higher Q-factor than the PMMA shell structure. In FIG. 13F the local amplitude of the contact resonance peak is given. It is the IR amplitude value at the local contact resonance, f_{CR}, that was obtained from the Lorentzian fit. For the chosen IR wavelength of 1730 cm⁻¹ matching the PMMA carbonyl absorption band, the image depicts the PMMA distribution, highlighting the PMMA shell structure around the PS core areas. In FIG. 13G, the IR amplitude is integrated over the contact resonance, i.e., the IR amplitude is summed up between 1744-1758 kHz. The result is similar to FIG. 13F and shows the PMMA distribution.

Note that this FV AFM-IR imaging mode described in FIG. 13 does not use frequency tracking based on a phase-locked loop (PLL). Instead, each xy image pixel contains a sweep over a contact resonance. Contact resonance frequency shifts can then be directly observed and analyzed for each pixel, as visualized in FIGS. 13C and 13D. Additional information, for instance about the local damping measured as a Q-factor, can be obtained, see FIG. 13E. In order to acquire an IR absorption image where the IR laser repetition rate is matching the local contact resonance, the amplitude at a fitted contact resonance can be displayed, see FIG. 13F. This is an IR absorption image comparable to what one would obtain for frequency-tracking with a PLL. In another alternative to PLL-based frequency tracking, signal integration in FIG. 13G over the contact resonance is insensitive to contact resonance shifts, as long as the integration boundaries are sufficiently large to cover any shift. So, in summary, FIG. 13 highlights how rapid frequency sweeps in FV AFM-IR in each pixel can provide additional sample information and deliver IR images free of mechanical artifacts (i.e., compensated for contact resonance shifts).

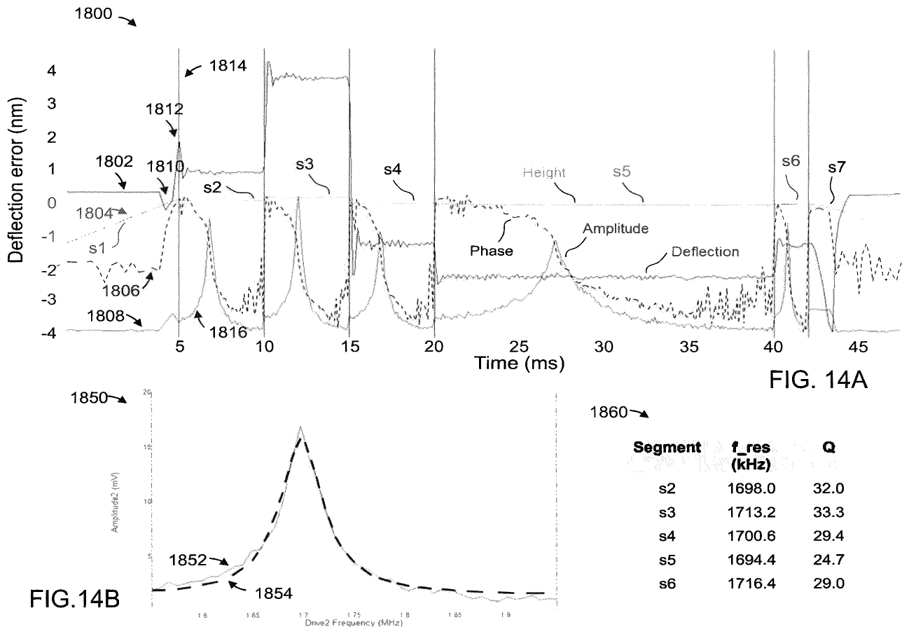

Another embodiment is discussed in FIG. 14. Here, in FIG. 14A, ramp-scripting is employed, i.e., for a single pixel or every spatial sample position in a FV AFM-IR scan, a sequence of user-defined approach, hold and retract segments is defined and executed during which IR absorption measurements are realized amongst other possible measurements. In the experimental force curve 1800, five (5) hold segments are shown. A gold-coated probe with 5 N/m spring constant was used on a 120 nm thin PMMA film and at an infrared laser wavelength of 1730 cm⁻¹, corresponding to the carbonyl absorption band in PMMA. The probe deflection 1802 is given together with the height 1804 and infrared optical signals of phase 1806 and absorption 1808. Note that the height is inverted compared to FIGS. 9 and 10, and the deflection error baseline is shifted vertically by ˜0.4 nm (still, only the difference between deflection error and baseline determines the holding forces during hold segments). As discussed before, at the end of the first approach segment s1 the tip snaps into contact with the sample in point 1810 and the tip-sample force is increased until the trigger threshold is reached; in this case, a user-defined force instead of for instance a height or height sensor value. Here, at point 1812 the force overshoots and is corrected by a small, reversed motion in height. Vertical lines such as 1814 mark the end of a segment, here of approach segment s1. With s2, a hold segment of 5 ms hold time follows. During that time the deflection, i.e., force, is kept constant.

In this example, during s2 the laser repetition rate frequency is swept from 1550 kHz to 1950 kHz, resulting in a Lorentzian absorption line shape 1816 for the absorption signal at the contact resonance of the probe of approximately 1700 kHz. As this absorption signal was measured with a Lock-In amplifier, a phase change around the resonance can be plotted for phase 1806 during segment s2. In hold segment s3, the force between tip and sample is increased further, i.e., the height is changed until the new force trigger threshold is met at a higher deflection value. In hold segment s4, the force has been adjusted again, but now the deflection is below the equilibrium deflection during approach segment s1, i.e., the tip is pulled towards the sample by adhesion forces, leading to a negative force between tip and sample. In hold segment s5 the deflection is decreased further and the pulling force increases. The hold time during s5 has been increased from 5 ms to 20 ms. In the last hold segment s6 the hold time is now only 2 ms during which a laser frequency sweep is successfully executed. Retract segment s7 ends this user-defined cycle in FV AFM-IR.

In panel 1850 of FIG. 14B, the IR absorption resonance curve (1816 of FIG. 14A) from hold segment s2 is plotted as curve 1852 as a function of the laser repetition rate together with a Lorentzian fit 1854. From the fit, quantities such as the center frequency can be extracted or the Q-factor. These parameters are summarized in table 1860 for all hold segments s2-s6. We observe that the lower the force the lower the contact resonance frequency and the Q-factor of the mode, although the data shows some hysteresis. This frequency-dependent resonance shift highlights the necessity for force control, which is given by force volume, but not by contact mode where deflection drift between spatial measurement positions is not measured or corrected. Looking at the presented time scales, one can see that a resonance curve with high signal-to-noise ratio can be obtained within at least 2 ms (see segment s6 in panel 1800). Even for a short hold segment of 0.5 ms we obtained decent signal to noise ratio (not shown). With such rapid frequency sweeps over a contact mode resonance, reasonably fast imaging is possible. As FIG. 11 suggests, approach and retract segments can be short, e.g., 5 ms each. With a 0.5-1 ms short hold segment that includes a resonance sweep an IR image of 256×256 pixels can be obtained within 12 min, and can be further improved to below 10 min with faster approach and retract segments for certain samples and conditions.

Acquiring resonance sweeps in each pixel of an image scan and evaluating those sweeps, e.g., by integrating the IR signal over the frequency sweep range, may have benefits over using a PLL for tracking contact resonance shifts that occur for instance between different sample materials or for different tip-sample interactions. A PLL might not be able to follow a frequency shift as fast as needed, especially if the laser-induced changes are small, e.g. for a sample with low absorption, or if the contact resonance shifts are large or fast. In such a case low sample absorption leads to noisy amplitude and phase signals so that the PLL tracking is compromised or impossible.

Another benefit of a contact resonance sweep is that it allows accounting for damping in the measured IR response. The probe acts as a detector to sense the laser induced surface pulse force. The surface pulse force causes, for instance, an oscillating photothermal expansion of the sample which is detected by the probe and typically amplified at the probe's contact resonance in resonance enhanced detection. The probe responds over the contact resonance curve, i.e., not just at a single frequency but over a typical Lorentzian line profile with a width proportional to damping or inversely proportional to the Q-factor. In that sense the contact resonance represents the probe's response function.

The higher the damping, the broader the contact resonance and the frequency range over which the probe can detect, but the less effective the detection at a single frequency. Integration over the contact resonance line shape ensures that the photothermal expansion is detected over all frequencies over which the specific probe resonance is sensitive and can be excited efficiently. This integral is proportional to the energy in the laser induced surface expansion and hence to the sample absorption. In comparison, detection at only a single frequency with or without PLL-based frequency tracking might misrepresent the sample absorption: for instance, two materials showing the same peak amplitude of the Lorentzian contact resonance would be recognized as absorbing equally. However, a different Q-factor for both materials would mean that the absorption is indeed different with higher absorption for the material with the larger damping (lower Q-factor) in this example. Hence, the surface pulse force that follows, for example, from averaging the lock-in amplifier amplitude signal over a resonance sweep, takes the resonance shape into account and is substantially independent of damping.

Note that the integral over the Lorentzian shaped line profile (also applicable for other profiles like a Gaussian profile) is proportional to the peak amplitude times the full width at half maximum, thus, to peak amplitude over Q-factor. Hence, obtaining the IR signal from the integration over the resonance sweep basically measures the peak height usually detected at a single fixed frequency with or without a PLL-based approach but now normalized by the Q-factor. In other words, the detected sample absorption by the probe is proportional to the area under the contact resonance curve, namely peak amplitude over Q-factor, while single-frequency detection with or without a PLL only captures the peak amplitude, not accounting for the broad probe detector response.

As an example, we turn again to FIGS. 13E-G. The bright PMMA distribution in the shell of the nanoparticles appear comparable in the IR absorption images of FIG. 13F for the peak amplitude signal extraction and FIG. 13G for the signal integration over the contact resonance. However, in FIG. 13F the darker areas corresponding to the PS core of the nanoparticles are on average brighter than the substrate surrounding the whole nanoparticle assembly. In FIG. 13G though, these PS domains are now darker than the substrate. This can be explained by the Q-factor distribution in FIG. 13E where the PS domains show a 50% larger Q-factor than the PMMA domains. In the integrated signal extraction of FIG. 13G the larger Q-factor decreases the IR absorption signal in the PS domains versus the PMMA domains since integration basically means normalizing the peak amplitude (displayed in FIG. 13F) by the Q-factor. Hence, frequency sweeping and signal integration over the contact resonance may reveal a higher IR signal contrast (depending on the Q-factor) and a better match to the true IR absorption of a sample.

Note that sweeping the frequency does not need to happen in a continuous fashion but can also happen step-wise, i.e., the light source repetition frequency can be stepped, even with a coarse step resolution. Instead of the continuous curve of IR signal resonance 1710 in FIG. 13 for the laser repetition rate sweep of 1720-1780 kHz, significantly less data points could have been collected. For instance, sweeping the frequency at a discrete step size of 2 kHz and hence collecting only 31 data points between 1720-1780 kHz obtains the same information. Subsequent fitting is possible with a line shape function such as a Lorentzian to extract peak amplitude, Q-factor, full width at half maximum, resonance frequency or area under the curve. From these parameters a signal integration over the resonance curve to represent the IR signal can also be replaced by calculating peak amplitude over Q-factor.

For spectroscopy, the resonance sweeps over a cantilever resonance within 0.5 ms up to 10s of ms (or minutes, if desired) can be employed per wavelength steps. That means that the laser wavelength is tuned, then the resonance frequency is swept to acquire an IR absorption signal at a cantilever mode as in 1852. An IR signal is then deduced from the sweep, either by using the peak amplitude value of a fit, the curve maximum, or the integration of the frequency sweep range, or other parameters from the sweep data indicative of an IR absorption or in general of a laser-induced signal. Such signal is then assigned to the wavelength for which it was taken, and the procedure can be repeated for a next wavelength step. As an example, the three (3) hold segments s2, s3 and s4 could have been collected at a constant deflection (in contrast to the non-constant one displayed in 1800) but for wavelength steps of 1728 cm⁻¹, 1730 cm⁻¹, and 1732 cm⁻¹, respectively. This way, an IR absorption spectrum with IR signal vs. a laser wavelength can be constructed from laser frequency sweeps at each wavelength step.

As discussed before, this method offers advantages over a PLL-based frequency tracking approach, where the latter may work imperfectly at low light-induced signals, or for fast and large resonance frequency shifts. While acquiring a wavelength-dependent spectrum (such as in FIG. 12) small signals regularly occur since materials seldom absorb everywhere over the entire probed spectral range. That means that there are wavelengths over a wavelength scan where the signal drops substantially and a PLL has difficulties to find a resonance, or only finds it with some delay. Recording a resonance sweep at each wavelength step on the other hand ensures that the correct contact resonance has been covered, even if the signal was weak. Furthermore, if two contact resonances are close together, a PLL could also jump between adjacent resonances and create an undesired, ill-defined mixture of sample responses intermittently probed at two resonances. Employing a frequency sweep approach may also show both resonances but they can be distinguished in post-processing, or can be integrated over, while a PLL can only follow one. Rapid frequency sweeps within 0.5 ms to 100 ms also offer speed benefits over other ways to find the contact resonance in AFM-IR such as rapid thermal tunes (U.S. Pat. No. 8,680,467).

Another important benefit of FV AFM-IR is the ability to easily access pulling forces in a controlled way. In FV AFM-IR the FV AFM-IR cycle could be constructed (either pre-defined or via ramp-scripting) to consist of an approach segment to engage on the sample at low trigger force, followed by a hold segment at even lower (or negative) force that would otherwise be too low for a successful engage, but would now be feasible since the tip is already in contact with the sample. Note that recent improvements in FV itself allow to approach and engage with the surface with a negative force setpoint, see U.S. Pat. No. 9,910,064. FV AFM-IR does hence allow controllable and repeatable positioning on delicate samples or nanoparticles while using negative or pulling forces during IR data acquisition. Such data acquisition may happen during the hold time, or during approach and retract segments, at adjustable approach/retract rates of for instance 100 μm/sec or slower. Contact mode based AFM-IR is not able to either scan or position the tip on delicate samples, nor provide a controlled force setpoint without deflection drift while on the sample of interest, nor does contact mode allow pulling experiments where the force is varied in a defined way under laser illumination for, as an example, absorption measurements on single molecules.

During the sequence of approach, hold and retract segments, other measurements than nanoscale infrared absorption ones can be carried out or combined with them, e.g. nanomechanical or nanoelectrical ones such as applying a tip or sample voltage for current measurements. Furthermore, parameters relevant for the infrared sample absorption can be switched between segments, e.g., one could switch to surface sensitive AFM-IR, or tapping AFM-IR, change tip-sample force with sub-nN accuracy, change the light polarization, laser power or laser pulse length, or change the laser wavelength either between segments or sweep it within a segment. Between segments the cantilever resonance mode frequency may also be changed as well, or the sweep range over which the frequency is swept to collect single or multiple cantilever resonances.

This approach is different from traditional 2D AFM data where each spatial position on the sample is assigned a single value, e.g. an IR absorption at a fixed wavelength or a surface potential in Kelvin probe force microscopy (KPFM). The datacube approach associates a multidimensional measurement with each sample position. So, each pixel in an FV AFM-IR image may contain a full IR spectrum (IR absorption as a function of wavelength) over the fingerprint spectral region. Or it may additionally include such IR spectra taken at a different light polarization (e.g. perpendicular to the tip right after acquisition in the same FV AFM-IR cycle at the usual parallel alignment to the tip). Or, in each pixel a tip voltage may have been applied, changing the IR spectral response as measured in the same hold segment or a consecutive one of the same FV AFM-IR cycle. In summary, FV AFM-IR allows to collect rich datacube information where each spatial pixel is linked to a full point spectrum with NanoIR, nanoelectrical or nanomechanical data, or a combination thereof. In such an integrated multidimensional datacube the data can be sliced along any axis or plane, e.g. to show a polarization- and wavelength-dependent IR response, or the IR absorption at a single wavelength deduced from a datacube with a full IR spectrum per pixel (this specific example is also called a hyperspectral scan). This big data approach can also be analyzed with principal component analysis and machine learning approaches.

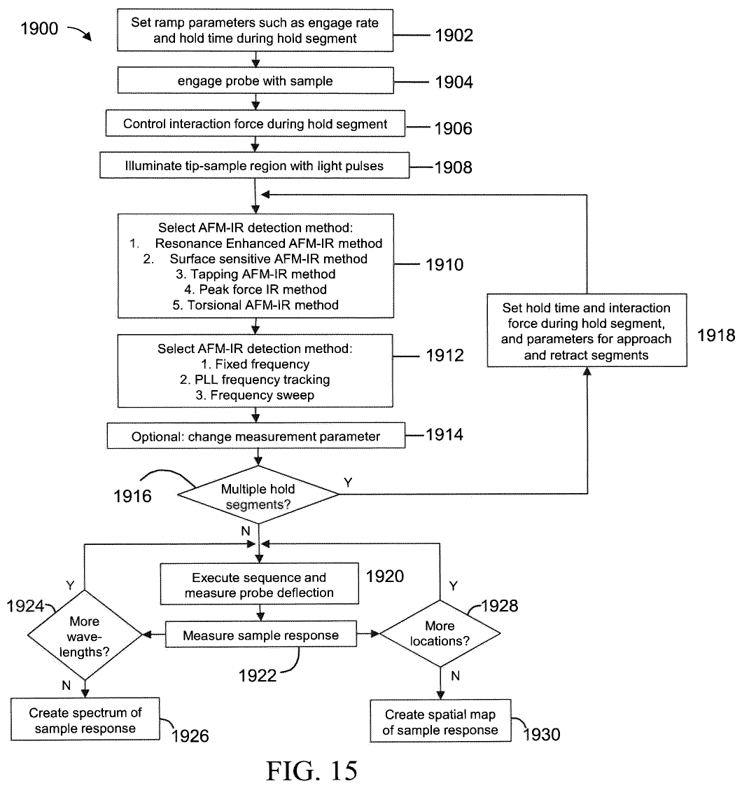

Some of the preferred embodiments are displayed in the flow chart 1900 in FIG. 15 for a multi-segment FV AFM-IR cycle. In Step 1902 the engage parameters are chosen that comprise the ramp rate, the hold time during the hold segment, the interaction force and other parameters such as the hold method/type (e.g., hold a force or height sensor) before the tip is engaged with the sample of interest in Step 1904. Note that the hold time or dwell time during the hold segment can be zero or non-zero (i.e., a zero hold time means that the hold segment is absent). After tip-sample contact is established in Step 1904, parameters might be adjusted, e.g. the interaction force in Step 1906, or also ramp rate and hold time during the hold segment. In Step 1908 the tip-sample region is illuminated with light pulses, e.g., from a wavelength and repetition rate tunable infrared laser source. Next, the AFM-IR detection method is selected in Step 1910 for the hold segment (or more generally, also including approach and retract segments if AFM-IR detection during non-constant force or height is desired). The different AFM-IR detection options comprise the resonance enhanced AFM-IR mode (or the original non-resonant mode), surface sensitive AFM-IR mode, tapping AFM-IR mode, peak force IR mode or torsional AFM-IR where the IR signal is detected not in the vertical deflection but the torsional deflection of the probe or from a combination of vertical and torsional deflection. Such torsional deflection readout is possible for resonance enhanced AFM-IR mode (or non-resonant one) but also surface sensitive AFM-IR mode, tapping AFM-IR mode, or peak force IR mode.

The light source repetition rate or pulse frequency is chosen in Step 1912. In the preferred embodiments the IR signal is maximized by resonantly driving a probe resonance with the light source pulses. In resonance enhanced AFM-IR mode, for instance, the probe resonance is the contact resonance. The light source repetition rate can be chosen to overlap with the contact resonance and then the repetition frequency is fixed (option 1) without automatic adjustment or following of any contact resonance changes. Note that the original non-resonant AFM-IR mode can also be applied with a single pulse. Additionally, while it is preferred to match the laser repetition rate with the probe contact resonance (or more generally with the probe resonance in case of tapping AFM-IR mode for instance), the frequencies can mismatch by 10% of the full-width at half-maximum of the probe resonance, or even 50% or 100% in order to still experience resonance enhancement, although at reduced and non-optimal efficiency. Option 2 is to enable a phase-locked loop (PLL) to follow any contact resonance shifts that may occur during scanning at different spatial xy locations or during spectra acquisition. Other frequency tracking methods are also possible as discussed before, e.g., dual-frequency resonance tracking (DFRT), dual AC resonance tracking (DART) or scanning probe resonance image tracking electronics (SPRITE). Option 3 would be a repetition rate frequency sweep of the light source over a defined frequency range to acquire the repetition rate dependent sample response such as 1426 (FIG. 10). Any contact resonance shift would be directly visible in a shift of the frequency-dependent sample response. An IR signal can be obtained by fitting such curve with a line profile like a Lorentzian fit and taking the fitted peak amplitude as the IR signal, or an integration over the swept frequency range may also represent the local IR signal. Integration (or averaging) over the swept frequency window ensures that the Q-factor is taken into account so that the deduced light-induced surface pulse force is substantially independent of damping. This is in contrast to conventional AFM-IR techniques where the measured signal is convoluted with the Q-factor, and the Q-factor is not determined. In a next Step 1914, measurement parameters may be adjusted for the hold segment. These might comprise the light source power, polarization or pulse length. In general, other parameters such as a sample or tip voltage, a magnetic field, the tip-sample interaction force may be chosen too for the hold segment.

In Step 1916 a choice is presented to add additional segments to the single force volume cycle. If so, in Step 1918 such segments are defined and parameters are set for the hold segment such as hold time and force, and for the approach and retract segments, if any. The measurement parameters in Steps 1910, 1912, 1914 are then defined for these new segments. The sequence of approach, hold and retract segments is then executed in Step 1920 and the probe deflection that carries the light induced changes is measured, typically in vertical deflection, but horizontal/lateral or a combination works as well. The sample response is deduced in Step 1922, usually as the amplitude signal delivered by a Lock-In amplifier with the probe deflection signal as input. Alternatively, an FFT might be used on the time-domain probe deflection data, or that time-domain data may be analyzed directly to extract the light induced surface pulse force for instance as the maximum amplitude of the light induced deflection changes or oscillations, as a root-mean-squared value or as an average of the absolute value of such oscillations. Once the sample response has been extracted, Step 1920 and 1922 can be repeated to collect sample responses at more wavelengths of the light source, a choice taken in Step 1924. The resulting spectrum of sample response as a function of wavelength may be created in Step 1926, representing an absorption spectrum after normalization by the wavelength-dependent laser power in a preferred embodiment. Alternatively, the wavelength can be kept constant while changing the sample locations in 1928 and repeating Steps 1920 and 1922. In such a case, a spatial map can be created in Step 1930 to indicate position-dependent infrared absorption, for instance. It is also possible to combine Steps 1924 and 1928 to create hyperspectral data: a spatial map that contains position-dependent spectra.

FV AFM-IR has advantages over other AFM-based spectroscopy techniques by providing a linear probe-sample engage in every pixel along with controlled time and force, preferably using hold segments during oscillation. Benefits in terms of minimized lateral forces (e.g., particularly useful when measuring soft samples) and drift correction are realized. Parallel mechanical mapping using force curve measurements in every x-y pixel is also made possible.

It is understood that in alternative embodiments, the wavelength region can be extended beyond the infrared of the preferred embodiment, for example to the ultraviolet, visible, near-infrared and terahertz or far-infrared spectral region. QCLs and optical parametric oscillators (OPOs) exist as pulsed and modulated light sources in the infrared. The UV, visible and near-IR is covered by laser sources such as solid state lasers, fiber lasers, diode lasers, optical parametric oscillators or gas lasers, as well as laser sources based on nonlinear frequency conversion comprising optical parametric generation, sum-frequency generation, harmonic generation, frequency combs and related methods. In the terahertz spectral region terahertz quantum cascade lasers are emerging, while terahertz gas lasers, terahertz antennas or free-electron lasers already exist to cover that range. In the extended wavelength range from UV to terahertz, the surface pulse force during laser pulsing can originate from several effects. In the terahertz region plasmon polaritons in graphene or cooper pair polaritons in superconductors exist that may induce an electromagnetic force between probe and sample under light excitation from charge redistribution and charge oscillation. Another example is phonon resonances leading to absorption and photo-expansion in the terahertz range. In the UV, visible and near-infrared range plasmonic resonances, e.g., in metal nanostructures, exist, absorbing energy for photo-expansion or altering electromagnetic fields through their charge oscillation or charge redistribution, thereby exerting a surface pulse force on the probe.

Such laser sources may not only emit narrowband, but also broadband. Broadband sources comprise large user-facilities such as a synchrotron, or table-top systems such as thermal globars as used in FTIR instruments, sources based on difference-frequency generation, or novel light sources, such as a laser-driven plasma source (Wagner et al., ACS Photonics 2018, 5, 4, 1467-1475). The spectral range of the broadband light source output might be tailored to only cover a small, narrowband region, e.g., using a bandpass filter, or a monochromator or spectrometer based on dispersion or diffraction. If the tip-sample region is illuminated with a broadband light source output, a wavelength-specific response may be extracted by placing the AFM tip at the output of an interferometer, e.g., a Michelson-type one. The setup is then identical to a standard Michelson-interferometer based FTIR spectrometer with broadband light input that is split by a beamsplitter where one part is then reflected off a fixed mirror and the second part is reflected off a movable mirror, before both reflections are recombined by the beamsplitter and focused onto the AFM probe. By sweeping the movable mirror the tip sees an interferogram of the light source output and records a mirror-position dependent sample response interferogram, from which a wavenumber or wavelength-dependent response can be calculated via a Fourier transform, analog to a standard FTIR spectrometer.

In another embodiment the sample is illuminated from the bottom instead of the top-down illumination of FIG. 8. Bottom illumination requires a transparent sample or sufficiently thin film (thickness within a few wavelengths) in the wavelength range of interest to allow transmission of light to the probed volume. Bottom illumination can have the benefit of less exposure of tip 1203 and probe 1201 to the laser pulses which can reduce artifacts that could occur when the probe itself absorbs light and gets heated. Another advantage is that bottom illumination may use a higher numerical aperture than top illumination since in top illumination the probe blocks part of the light while in bottom illumination the entire half space below the probe may be used for light focusing. Hence a smaller focus may result leading to a lower power requirement for the laser or less sample heating. The main benefit of bottom illumination is that it allows FV AFM-IR of samples in liquid environment, as described below.

For bottom illumination the sample may be placed or spin-coated, for instance, on a prism of a transparent material for the wavelength range of interest, e.g., ZnSe, ZnS, Si, diamond or Germanium. The laser beam may undergo total internal reflection in order for the beam to propagate inside the sample while being evanescent in the air. In this way, only the sample is exposed to the radiation leading to strong light-matter interaction. Alternatively, the laser beam may transmit without total internal reflection through a prism or a flat sample substrate. Such transmission geometry does not confine the light to the sample only, but also exposes the probe 1201 to the light beam.

Such bottom-up configuration is most useful for measuring in liquid. The tip and sample region would then be surrounded by a fluid to study, for instance, biological specimen in their natural environment or electrochemical reactions. Since water absorption is minimized in the UV to near-infrared spectral region compared to the infrared region, water can be used as a liquid to study near-infrared absorption of biological matter in its native environment. Other suitable liquids, e.g., heavy water, with no or minimal absorption in the wavelength range of interest may be used to extend the wavelength range. Compared to top-down illumination with a longer light pass through the liquid, the water absorption would be minimized for bottom irradiation.

FV AFM-IR in fluid, whether realized in a top-down or bottom-up geometry, may offer distinct benefits using the preferred IR detection methods of resonance enhanced AFM-IR or surface sensitive AFM-IR. It is in general difficult to operate tapping AFM in fluid since the probe resonances are heavily damped. A non-resonant AFM mode such as contact mode or force volume mode is more suited, and the latter is then preferred with its vanishing lateral forces and precise force control. Furthermore, IR detection in surface sensitive FV AFM-IR may be preferred over resonance enhanced FV AFM-IR, given that the light source repetition rate is different from the IR detection frequency so that the light does not directly excite background signals in liquid at the detection frequency.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

We claim:

1. An apparatus for characterizing sub-micron regions of a sample with an atomic force microscope (AFM), the apparatus comprising:
a z-scanner or piezo to move at least one of a probe of the AFM and the sample to cause a tip of the probe to interact with the sample in at least one approach segment, at least one hold segment with non-zero hold time and at least one retract segment;
at least one controller to control the transient tip-sample interaction force during the at least one of an approach, hold and retract segment;
a light source to illuminate the tip-sample region with light pulses to induce sample modifications;
a detector to measure probe deflection due at least to the induced sample modification, and generate a signal corresponding to a light induced probe deflection change; and
wherein the at least one controller extracts sample responses to the light pulses from the measured probe deflections.

2. The apparatus of claim 1, wherein the sample responses are extracted at different positions on the sample and wherein the movement between different positions is substantially free of lateral tip-sample interaction forces.

3. The apparatus of claim 1, wherein the light induced probe deflection changes are vertical, horizontal, torsional, or a combination thereof.

4. The apparatus of claim 1, wherein the light source is an infrared radiation source and the at least one controller creates a spatially resolved map indicative of absorbed infrared radiation using the sample responses, and wherein the movement of the probe between sample positions is substantially free of lateral tip-sample interaction forces.

5. The apparatus of claim 1, wherein the sample responses are extracted with at least one of a resonance enhanced AFM-IR method, a surface sensitive AFM-IR method, a tapping AFM-IR method, a photo-induced force microscopy (PiFM) method, a peak force IR method and a torsional AFM-IR method.

6. The apparatus of claim 1, wherein the tip-sample interaction force during the at least one hold segment is a pulling force.

7. The apparatus of claim 1, wherein the spatial resolution of the sample responses is sub-10 nm.

8. The apparatus of claim 1, wherein the sample responses are extracted for different wavelengths of the light source.

9. The apparatus of claim 1, wherein the sample response at the at least one segment is indicative of at least one of nano-mechanical and nano-electrical properties of the sample.

10. The apparatus of claim 1, wherein in the at least one segment the light source illuminates the tip-sample region with light pulses at at least two pulse repetition rates.

11. The apparatus of claim 10, wherein the at least one controller, from the at least two sample responses to the light pulses at the at least two pulse repetition rates, determines elastic and viscoelastic sample properties.

12. The apparatus of claim 10, wherein the sample responses are extracted for different wavelengths of the light source to create a spectrum of the light-induced sample responses.

13. The apparatus of claim 1, wherein in the at least one segment at least one of the following parameters is changed: light source repetition rate, light source wavelength, light source power, light source pulse length, light source polarization, sample voltage, tip voltage, force, z position, and a ‘datacube’ is created with the sample response to the light illumination as function of selected parameters over a selected range.

14. The apparatus of claim 1, wherein at least one hold segment has a hold time below 100 ms.

15. The apparatus of claim 10, wherein the sample responses are extracted at different repetition rates of the light source to control the probing depth.

16. The apparatus of claim 5, wherein probe resonance shifts are compensated with a frequency tracking method.

17. The apparatus of claim 10, wherein from the light source repetition rate dependent sample responses are extracted at least one of a surface pulse force, the sample absorption, the peak amplitude of the resonance, the Q-factor of the resonance, the full-width at half-maximum of the resonance, the peak amplitude of the resonance divided by the Q-factor, the center frequency of the resonance, the integral over the resonance, and the average value over the resonance.

18. A method of characterizing sub-micron regions of a sample with an atomic force microscope (AFM) having a probe, the method comprising:
causing a tip of the probe of the AFM to interact with the sample in at least one approach segment, at least one hold segment with non-zero hold time and at least one retract segment by moving at least one of the probe and the sample;
controlling the transient tip-sample interaction force during the at least one of the approach, hold and retract segments;
illuminating the tip-sample region with light pulses from a light source to induce sample modifications;
measuring probe deflection due at least to the induced sample modifications, and generating signals corresponding to the light induced probe deflection changes; and
extracting sample responses to the light pulses from the measured probe deflection.

19. The method of claim 18, wherein the sample responses are extracted at different positions on the sample and wherein the movement between different positions is substantially free of lateral tip-sample interaction forces.

20. The method of claim 18, wherein in the at least one segment the light source illuminates the tip-sample region with light pulses at at least two pulse repetition rates.

21. The method of claim 20, wherein from the light source repetition rate dependent sample responses is extracted at least one of a surface pulse force, the sample absorption, the peak amplitude of the resonance, the Q-factor of the resonance, the full-width at half-maximum of the resonance, the peak amplitude of the resonance divided by the Q-factor, the center frequency of the resonance, the integral over the resonance, and the average value over the resonance.

22. The method of claim 18, wherein the wavelength of the light source is swept to create a spectrum of the light induced sample responses.

23. An apparatus for characterizing sub-micron regions of a sample with an atomic force microscope (AFM) having a probe, the apparatus comprising:
a z-scanner or piezo to move at least one of the probe and the sample to cause a tip of the probe to interact with the sample in at least one approach and at least one retract segment;
at least one controller to control the transient tip-sample interaction force during the at least one of an approach and a retract segment;
a light source to illuminate the tip-sample region with light pulses at at least two pulse repetition rates to induce a sample modification;
a detector to measure probe deflection due at least to the induced sample modifications, and generate signals corresponding to the light induced probe deflection changes;
wherein the at least one controller extracts at least two sample responses to the light pulses from the measured probe deflection; and
wherein, from the at least two sample responses, a light induced surface pulse force is deduced that is substantially independent of damping.

24. The apparatus of claim 23, wherein the light induced surface pulse force is substantially independent of damping using at least one of dividing the peak amplitude of the resonance by the Q-factor, integrating over the resonance, and computing an average value over the resonance.
